(19) United States
(12) Patent Application Publication
(10) Pub. No.: US 2026/0132065 A1
(43) Pub. Date: May 14, 2026

(54) METHOD FOR PRODUCING PURE WATER FROM WHICH BORON HAS BEEN REMOVED, PURE WATER PRODUCTION DEVICE, AND ULTRAPURE WATER PRODUCTION SYSTEM

(71) Applicant: NOMURA MICRO SCIENCE CO., LTD., Atsugi-Shi (JP)

(72) Inventors: Yukio NOGUCHI, Atsugi-Shi (JP); Kengo YAMADA, Atsugi-Shi (JP)

(73) Assignee: NOMURA MICRO SCIENCE CO., LTD., Atsugi-Shi (JP)

(21) Appl. No.: 19/118,490

(22) PCT Filed: Oct. 3, 2023
(86) PCT No.: PCT/JP2023/036068

§ 371 Date: Apr. 4, 2025

(30) Foreign Application Priority Data
Oct. 4, 2022 (JP) 2022-160066

(51) Int. Cl. C02F 9/00; C02F 1/20; C02F 1/32; C02F 1/42; C02F 1/44; C02F 1/469; C02F 1/66; C02F 101/10

(52) U.S. Cl. CPC C02F 9/00; C02F 1/20; C02F 1/32; C02F 1/42; C02F 2001/427; C02F 1/441; C02F 1/444; C02F 1/4695; C02F 1/66; C02F 2101/108; C02F 2201/004; C02F 2201/005; C02F 2209/06; C02F 2209/07

(57) ABSTRACT

A pure water production device and method are capable of suppressing scale clogging in a reverse osmosis membrane, stably and efficiently producing pure water over a long period. The pure water production method obtains pure water by passing raw water sequentially through multiple reverse osmosis membranes. An alkali treatment step passes alkaline water through one stage, and an acid treatment step passes acidic water through another, executed in a predetermined order. A first treatment period uses a first reverse osmosis membrane for the alkali treatment step and a second for the acid treatment step, while a second treatment period swaps their roles. These periods repeat at a predetermined interval, with the first and second reverse osmosis membranes swapped.

### CROSS-REFERENCE TO RELATED APPLICATIONS

This application is a 35 U.S.C. § 371 national phase of PCT International Application No. PCT/JP2023/036068, filed Oct. 3, 2023, which claims the benefit of priority under 35 U.S.C. § 119 to Japanese Patent Application No. 2022-160066, filed Oct. 4, 2022, the contents of which are incorporated herein by reference in its entirety.

### FIELD

The present invention relates to a method for producing pure water from which boron has been removed, a pure water production device, and an ultrapure water production system using same.

### BACKGROUND

As a method for producing pure water by treating raw water containing boron, a pure water production method in which a reverse osmosis membrane treatment is performed after the pH of raw water is adjusted to 9.2 or higher by adding an alkali to the raw water has been known. In this method, the specific resistance of treated water is also increased by adding an acid to permeate water from which boron has been removed and further subjecting same to a reverse osmosis membrane treatment (see, for example, Patent Literatures 1 and 2).

### CITATION LIST

### Patent Literature

Patent Literature 1
Japanese Patent Laid-Open No. 11-128921
Patent Literature 2
Japanese Patent Laid-Open No. 11-128922

### SUMMARY

### Technical Problem

Although the boron removal ratio is improved by increasing the pH of water to 10 or higher, scale clogging is more likely to occur in a reverse osmosis membrane due to hardness caused by calcium, magnesium, and the like as the pH increases. Therefore, in conventional pure water production methods involving removal of boron, suppression of scale clogging is attempted by providing a hardness removal mechanism or a degassing device with a high decarboxylation capability in a preceding stage. On the other hand, when the pH of water fed to a reverse osmosis membrane is adjusted to 5 or lower, although hardness scale is prevented from forming, silica scale is likely to form.

When hardness scale clogging occurs, scale cleaning is conducted by passing an acidic cleaning agent having a pH of about 1 to 3 through the reverse osmosis membrane, for example. When silica scale clogging occurs, scale cleaning is conducted by passing an alkaline cleaning agent having a pH of 11.5 to 13 through the reverse osmosis membrane, for example.

In both cases of hardness scale clogging and silica scale clogging, it is difficult to completely prevent the scale clogging, and scale clogging occurs even in a short-term operation according to the quality of raw water and operating conditions. As scale clogging progresses, it becomes necessary to stop the device for backwashing or cleaning of the reverse osmosis membrane, installation of cleaning equipment, or membrane replacement, and pure water production efficiency is decreased. Therefore, for example, continuous operation is often maintained for a period of six months to over a year as long as possible, avoiding cleaning of the reverse osmosis membrane, and cleaning is conducted when a significant decrease in permeate flow rate or a significant increase in differential pressure between the feed side and the permeation side makes continuous operation difficult, for example. However, with this operational approach, tough crystals may grow as a scale component on a surface of the reverse osmosis membrane when continuous operation becomes difficult, and physical properties of the membrane surface may change and deteriorate during the crystal growth.

When such hard scale forms on a surface of a reverse osmosis membrane, cleaning is conducted for a long time with a high concentration of a chemical, and deterioration of the reverse osmosis membrane due to the chemical is thus likely to progress. In addition, even when cleaning is conducted, the membrane surface deteriorated simultaneously with crystal growth as water passes therethrough is not restored; therefore, deterioration of the quality of water treated with the reverse osmosis membrane after cleaning cannot be avoided.

On the other hand, it is also possible to frequently repeat cleaning so as not to form hard scale. However, this method is not practical, because it is not only required to stop operation frequently, but also the water discharge amount becomes excessively large due to repeated cleaning, and reuse of the discharged water is also difficult. That is, from the viewpoints of suppressing deterioration of a reverse osmosis membrane and reducing the amount of a chemical used, a method that can produce pure water with a high water recovery ratio without conducting scale cleaning and without stopping a pure water production device is desired.

The present invention has been made to solve the above-described problem, and an object thereof is to provide a pure water production device and a pure water production method, capable of suppressing scale clogging in a reverse osmosis membrane and thereby stably and efficiently producing pure water over a long period without cleaning the reverse osmosis membrane.

### Solution to Problem

A pure water production method of an embodiment is a pure water production method obtaining pure water from which boron has been removed by passing raw water sequentially through two or more stages of reverse osmosis membranes, the method characterized in that: an alkali treatment step of passing alkaline water to be treated through a reverse osmosis membrane of one stage among the reverse osmosis membranes and an acid treatment step of passing acidic water to be treated through a reverse osmosis membrane of another stage among the reverse osmosis membranes are executed in a predetermined order; and a first treatment period in which a first reverse osmosis membrane is used in the alkali treatment step and a second reverse osmosis membrane is used in the acid treatment step and a second treatment period in which the second reverse osmosis membrane is used in the alkali treatment step and the first reverse osmosis membrane is used in the acid treatment step are repeated at a predetermined interval, with the first reverse osmosis membrane and the second reverse osmosis membrane swapped.

In the pure water production method of the embodiment, it is preferable that: in the first treatment period, alkaline water to be treated be passed through the first reverse osmosis membrane to execute the alkali treatment step, permeate water of the first reverse osmosis membrane be adjusted to be acidic, and the produced acidic water to be treated be passed through the second reverse osmosis membrane to execute the acid treatment step; in the second treatment period, alkaline water to be treated be passed through the second reverse osmosis membrane to execute the alkali treatment step, permeate water of the second reverse osmosis membrane be adjusted to be acidic, and the produced acidic water to be treated be passed through the first reverse osmosis membrane to execute the acid treatment step; the pH of the alkaline water to be treated be 9.0 or higher and 11.0 or lower; and the pH of the acidic water to be treated be 5.0 or lower.

It is preferable that the pure water production method of the embodiment further have, before the alkali treatment step, a step of passing raw water with a pH of 5.0 or higher and 7.5 or lower through a third reverse osmosis membrane.

In the pure water production method of the embodiment, it is preferable that: in the first treatment period, acidic water to be treated be passed through the second reverse osmosis membrane to execute the acid treatment step, permeate water of the second reverse osmosis membrane be adjusted to be alkaline, and the produced alkaline water to be treated be passed through the first reverse osmosis membrane to execute the alkali treatment step; in the second treatment period, acidic water to be treated be passed through the first reverse osmosis membrane to execute the acid treatment step, permeate water of the first reverse osmosis membrane be adjusted to be alkaline, and the produced alkaline water to be treated be passed through the second reverse osmosis membrane to execute the alkali treatment step; the pH of the alkaline water to be treated be 9.0 or higher and 11.0 or lower; and the pH of the acidic water to be treated be 5.0 or higher and 6.0 or lower.

A pure water production device of an embodiment is a pure water production device having two or more reverse osmosis membrane devices connected in series and producing pure water from which boron has been removed, the pure water production device characterized by having: a raw water feed pipe that feeds raw water; a first reverse osmosis membrane device; a second reverse osmosis membrane device; a first adjustment mechanism that adjusts water to be treated to be alkaline or acidic; a second adjustment mechanism that adjusts water to be treated to either acidic or alkaline, reversing the liquid property adjusted by the first adjustment mechanism; a first treatment pathway allowing raw water to pass through the first adjustment mechanism, the first reverse osmosis membrane device, the second adjustment mechanism, and the second reverse osmosis membrane device in this order; a second treatment pathway allowing raw water to pass through the first adjustment mechanism, the second reverse osmosis membrane device, the second adjustment mechanism, and the first reverse osmosis membrane device in this order; a switching mechanism capable of switching the first treatment pathway and the second treatment pathway; and a control mechanism that controls the switching mechanism to switch the first treatment pathway and the second treatment pathway at each end of a predetermined treatment period.

In the pure water production device of the embodiment, it is preferable that the first adjustment mechanism be an alkali adjustment mechanism that adjusts raw water to be alkaline, and the second adjustment mechanism be an acid adjustment mechanism that adjusts water to be treated to be acidic.

In the pure water production device of the embodiment, it is preferable that the first treatment pathway have a first feed pipe that feeds raw water to the feed side of the first reverse osmosis membrane device, a second feed pipe that feeds permeate water of the first reverse osmosis membrane device to the second adjustment mechanism, a third feed pipe that feeds water to be treated after passing through the second adjustment mechanism to the feed side of the second reverse osmosis membrane device, a fourth feed pipe that sends permeate water of the second reverse osmosis membrane device to a subsequent stage, and four switching valves interposed into the first to fourth feed pipes, respectively; the first adjustment mechanism be disposed on the upstream side of the switching valve of the first feed pipe; the second treatment pathway have a fifth feed pipe that feeds raw water to the feed side of the second reverse osmosis membrane device, a sixth feed pipe that feeds permeate water of the second reverse osmosis membrane device to the second adjustment mechanism, a seventh feed pipe that feeds water to be treated after passing through the second adjustment mechanism to the feed side of the first reverse osmosis membrane device, an eighth feed pipe that sends permeate water of the first reverse osmosis membrane device to a subsequent stage, and four switching valves interposed into the fifth to eighth feed pipes, respectively; the first adjustment mechanism be disposed on the upstream side of the switching valve of the sixth feed pipe; and the control mechanism control the eight switching valves to switch the first treatment pathway and the second treatment pathway.

In the pure water production device of the embodiment, it is preferable that the first adjustment mechanism be an acid adjustment mechanism that adjusts raw water to be weakly acidic; and the second adjustment mechanism be an alkali adjustment mechanism that adjusts water to be treated to be alkaline.

An ultrapure water production system of an embodiment is an ultrapure water production system including a primary pure water system and a secondary pure water system in this order, the ultrapure water production system characterized in that the primary pure water system includes the pure water production device according to an embodiment and, in a subsequent stage thereof, an ultraviolet oxidation device and an electrodeionizer; the secondary pure water system includes an ultraviolet oxidation device, a non-regenerating polisher, a membrane degassing device, and an ultrafiltration device in this order; and the ultrapure water production system produces ultrapure water having a boron concentration of 0.1 μg/L or less.

It should be noted that in the present specification, the symbol “-“ represents a numerical value range from a value on the left of the symbol to a value on the right of the symbol.

### Advantageous Effect of Invention

According to a pure water production device and a pure water production method of the present invention, by suppressing scale clogging in a reverse osmosis membrane over a long period, pure water can be stably and efficiently produced over a long period without cleaning the reverse osmosis membrane.

According to a pure water production system of the present invention, by suppressing scale clogging in a reverse osmosis membrane provided on the preceding stage side of the ultrapure water production system over a long period, ultrapure water can be stably and efficiently produced over a long period without cleaning the reverse osmosis membrane.

### BRIEF DESCRIPTION OF THE DRAWINGS

FIG. 1 is a block diagram diagrammatically illustrating a pure water production method of a first embodiment.

FIG. 2 is a block diagram diagrammatically illustrating a pure water production method of a second embodiment.

FIG. 3 is a block diagram schematically illustrating a pure water production device of a third embodiment.

FIG. 4 is a block diagram schematically illustrating a pure water production device of a first modification of the third embodiment.

FIG. 5 is a block diagram schematically illustrating a pure water production device of a fourth embodiment.

FIG. 6 is a diagram explaining a first treatment pathway in the pure water production device of the fourth embodiment.

FIG. 7 is a diagram explaining a second treatment pathway in the pure water production device of the fourth embodiment.

FIG. 8 is a diagram schematically representing the treatment pathway in a first treatment period when a four-way valve is used.

FIG. 9 is a diagram schematically representing the treatment pathway in a second treatment period when a four-way valve is used.

FIG. 10 is a block diagram schematically illustrating a pure water production device of a first modification of the fourth embodiment.

FIG. 11 is a diagram schematically representing an arrangement of a fourth reverse osmosis membrane device when a four-way valve is used.

FIG. 12 is a block diagram diagrammatically illustrating a configuration of an ultrapure water production system of an embodiment.

FIG. 13 is a graph representing a relationship between the pH of water to be treated of a reverse osmosis membrane device and the boron removal ratio and the resistivity of treated water.

FIG. 14 is a graph representing a relationship between the pH of water to be treated of a reverse osmosis membrane device and the resistivity of treated water.

FIG. 15 is a graph representing changes in the water flow time and the permeate water flow rate when the pH of water to be treated of a reverse osmosis membrane device is adjusted to 9, 10.5, and 11.

FIG. 16 is a graph representing changes in the permeate water flow rate immediately after starting treatment with the pH of water to be treated of a reverse osmosis membrane device adjusted to 3, 4, and 6.

FIG. 17 is a graph representing changes in the treated water flow rate when preceding and subsequent stages of two reverse osmosis membrane devices are swapped every 90 days.

FIG. 18 is a graph representing changes in the permeate water quality of second and third stages of reverse osmosis membrane devices under the operating conditions shown in FIG. 17.

### DETAILED DESCRIPTION OF EMBODIMENTS

Hereinafter, embodiments of the present invention will be described. A pure water production method of the present embodiment is a method for producing pure water used in the electronic industry such as semiconductor production and as medicinal water. The pure water production method of the present embodiment is a method for producing pure water from which boron has been removed by passing raw water sequentially through two or more stages of reverse osmosis membranes, the method having an alkali treatment step of passing alkaline water to be treated through the reverse osmosis membrane of one stage and an acid treatment step of passing acidic water to be treated through the reverse osmosis membrane of the other stage. The alkali treatment step and the acid treatment step are executed in a predetermined order, the acid treatment step may be executed after the alkali treatment step, and the alkali treatment step may be executed after the acid treatment step. The pure water production method of the present embodiment is characterized in that a first treatment period in which a first reverse osmosis membrane is used in the alkali treatment step and a second reverse osmosis membrane is used in the acid treatment step and a second treatment period in which the second reverse osmosis membrane is used in the alkali treatment step and the first reverse osmosis membrane is used in the acid treatment step are repeated at a predetermined interval, with the first reverse osmosis membrane and the second reverse osmosis membrane swapped. The orders of the alkali treatment step and the acid treatment step in the first treatment period and the second treatment period are set to be identical to each other. This method will be explained in detail below using specific examples.

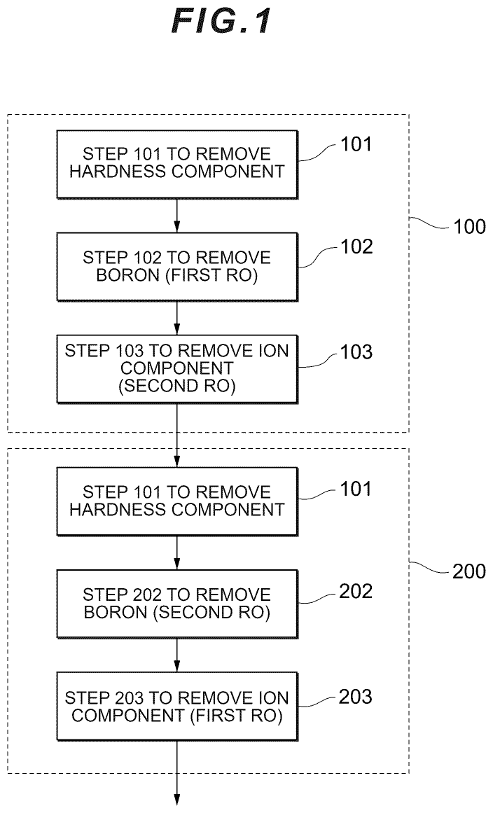

FIG. 1 is a block diagram diagrammatically illustrating a pure water production method of a first embodiment. As illustrated in FIG. 1, the pure water production method of the first embodiment includes a step 101 of subjecting raw water to a reverse osmosis membrane treatment to remove a hardness component, a step 102 of subjecting water to be treated from which the hardness component has been removed to a reverse osmosis membrane treatment after the water to be treated is adjusted to be alkaline to remove boron, and a step 103 of subjecting water to be treated from which boron has been removed to a reverse osmosis membrane treatment after the water to be treated is adjusted to be acidic to remove an ion component.

In the pure water production method of the first embodiment illustrated in FIG. 1, the step 102 corresponds to the alkali treatment step, and the step 103 corresponds to the acid treatment step. The pH of the alkaline water to be treated in the step 102 is 9.0 or higher and 11.0 or lower and more preferably 9.2 or higher and 10.5 or lower, from the point of improving the removal ratio of boron. The pH of the acidic water to be treated in the step 103 is preferably 5.0 or lower and more preferably 4.5 or lower, and preferably 2.0 or higher and more preferably 3.0 or higher, from the point of improving the removal ratio of the ion component. That is, the pH is preferably 2.0 or higher and 5.0 or lower and more preferably 3.0 or higher and 4.5 or lower. Note that, a step of passing water through one or more additional stages of reverse osmosis membranes may be provided between the step 102 and the step 103 and between a step 202 and a step 203, or after both steps for the purpose of removing the ion component. A booster pump, a degassing device, or a tank may be disposed between the reverse osmosis membranes, if necessary.

In the pure water production method of the present embodiment, after the step 101 to remove the hardness component, the step 102 to remove boron, and the step 103 to remove the ion component are continued in this order for a predetermined period, the reverse osmosis membrane device (first reverse osmosis membrane device (first RO)) used in the step 102 to remove boron and the reverse osmosis membrane device (second reverse osmosis membrane device (second RO)) used in the step 103 to remove the ion component are swapped, and the step 202 to remove boron is executed in the second reverse osmosis membrane device, and the step 203 to remove the ion component is executed using the first reverse osmosis membrane device. Then, a treatment period 100 (first treatment period) in which the step 101 to remove the hardness component, the step 102 to remove boron, and the step 103 to remove the ion component are executed in this order, and a treatment period 200 (second treatment period) in which the step 101 to remove the hardness component, the step 202 to remove boron, and the step 203 to remove the ion component are executed in this order are alternately repeated at a predetermined period. The swapping of the first reverse osmosis membrane device and the second reverse osmosis membrane device is realized by combining a valve and a pipe and configuring same such that flow paths for water to be treated can be switched. In addition, instead of the method in which a pipe for switching flow paths is provided, the swapping can be realized also by extracting two reverse osmosis membranes or reverse osmosis membrane modules and interchanging the positions thereof.

In the pure water production method of the present embodiment, in the treatment period 100, although the hardness component is removed in the step 101, the hardness component may leak into the permeate water of the reverse osmosis membrane device depending on the water quality or the operation period. In the first reverse osmosis membrane device, since the alkaline water to be treated is treated, when the water to be treated includes a hardness component, hardness scale clogging is likely to progress. In addition, in the second reverse osmosis membrane device which treats the acidic water to be treated, scale clogging due to silica is likely to progress. Therefore, before scale clogging in the first and second reverse osmosis membrane devices deteriorates the water recovery ratio, the first reverse osmosis membrane device and the second reverse osmosis membrane device are swapped, and the treatment period 200 is executed. In the treatment period 200, the first reverse osmosis membrane device treats, in the step 203, the water to be treated, which has been adjusted to be acidic; and the hardness component is dissolved in an acid, and the scale clogging is ameliorated during this process. In addition, in the second reverse osmosis membrane device in which scale clogging due to silica has progressed, the silica scale is dissolved in an alkali by treating the water to be treated, which has been adjusted to be alkaline, in the step 202, and the scale clogging is ameliorated. In the treatment period 200, hardness scale clogging in the second reverse osmosis membrane device undergoing the step 202 and silica scale clogging in the first reverse osmosis membrane device undergoing the step 203 may progress; however, the scale clogging of the first and second reverse osmosis membrane devices is ameliorated in the same manner as in the treatment period 200 by executing the treatment period 100 with the first reverse osmosis membrane device and the second reverse osmosis membrane device swapped again before the water recovery ratio decreases due to the scale clogging. Scale clogging in the first and second reverse osmosis membrane devices can be prevented from progressing over a long period in this manner, and pure water can thus be stably and efficiently produced over a long period. Furthermore, since the acid and alkali conditions employed in the step 102 (step 202) and the step 103 (step 203) are acid and alkali conditions milder than chemicals generally used for scale cleaning, deterioration of the reverse osmosis membranes can also be suppressed, and pure water with high water quality can be stably produced over a long period as a result.

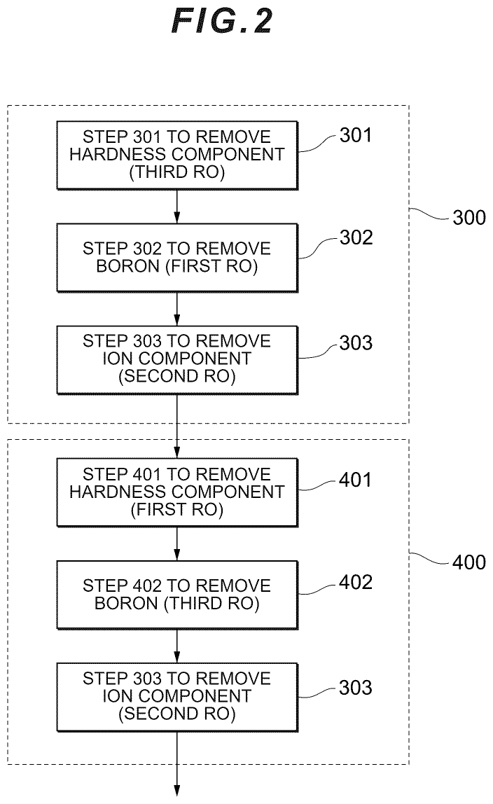

FIG. 2 is a block diagram diagrammatically illustrating a pure water production method of a second embodiment. As illustrated in FIG. 2, the pure water production method of the second embodiment includes a step 301 of subjecting raw water to a reverse osmosis membrane treatment after the raw water is adjusted to be weakly acidic to remove a hardness component, a step 302 of subjecting water to be treated from which the hardness component has been removed to a reverse osmosis membrane treatment after the water to be treated is adjusted to be alkaline to remove boron, and a step 303 of subjecting water to be treated from which boron has been removed to a reverse osmosis membrane treatment after the water to be treated is adjusted to be acidic to remove an ion component.

In the pure water production method of the second embodiment illustrated in FIG. 2, the step 302 corresponds to the alkali treatment step, and the step 301 corresponds to the acid treatment step. The pH of the acidic water to be treated in the step 301 is preferably 5 or higher and 6 or lower from the point of improving the removal ratio of the hardness component. The pH of the alkaline water to be treated in the step 302 is 9.0 or higher and 11.0 or lower and more preferably 9.2 or higher and 10.5 or lower, from the point of improving the removal ratio of boron. Note that, a step of passing water through one or more additional stages of reverse osmosis membranes may be provided between the step 302 and the step 303 and between a step 402 and a step 403, or after these steps for the purpose of removing the ion component. A booster pump, a degassing device, or a tank may be disposed between the reverse osmosis membranes, if necessary.

In the pure water production method of the present embodiment, after the step 301 to remove the hardness component, the step 302 to remove boron, and the step 303 to remove the ion component are continued in this order for a predetermined period, the reverse osmosis membrane device (third reverse osmosis membrane device (third RO)) used in the step 301 to remove the hardness component and the reverse osmosis membrane device (first reverse osmosis membrane device) used in the step 302 to remove the boron are swapped, and a step 401 to remove the hardness component is executed using the first reverse osmosis membrane device, and a step 402 to remove boron is executed in the third reverse osmosis membrane device. Then, a treatment period 300 (first treatment period) in which the step 301 to remove the hardness component, the step 302 to remove boron, and the step 303 to remove the ion component are executed in this order, and a treatment period 400 (second treatment period) in which the step 401 to remove the hardness component, the step 402 to remove boron, and the step 303 to remove the ion component are executed in this order are alternately repeated at a predetermined period. The swapping of the first reverse osmosis membrane device and the third reverse osmosis membrane device is realized by combining a valve and a pipe and configuring same such that flow paths for water to be treated can be switched. At this time, instead of the method in which a pipe for switching flow paths is provided, the swapping can be realized also by extracting two reverse osmosis membranes or reverse osmosis membrane modules and interchanging the positions thereof.

In the pure water production method of the present embodiment, in the treatment period 300, although the hardness component is removed in the step 301, the hardness component may leak into the permeate water of the third reverse osmosis membrane device depending on the water quality or the operation period, and scale clogging may progress in the subsequent first reverse osmosis membrane device. In addition, in the third reverse osmosis membrane device which treats weakly acidic water to be treated, scale clogging due to silica is likely to progress. Therefore, before scale clogging in the first and third reverse osmosis membrane devices deteriorates the water recovery ratio, the first reverse osmosis membrane device and the third reverse osmosis membrane device are swapped, and the treatment period 400 is executed. In the treatment period 400, the first reverse osmosis membrane device treats, in the step 401, the water to be treated, which has been adjusted to be weakly acidic; and the hardness scale is dissolved in an acid, and the scale clogging is ameliorated during this process. In addition, in the third reverse osmosis membrane device in which scale clogging due to silica has progressed, the silica scale is dissolved in an alkali by treating the water to be treated, which has been adjusted to be alkaline, in the step 402, and the scale clogging is ameliorated. In the treatment period 400, hardness scale clogging in the third reverse osmosis membrane device undergoing the step 402 and silica scale clogging in the first reverse osmosis membrane device undergoing the step 401 may progress; however, the scale clogging of the first and third reverse osmosis membrane devices is ameliorated in the same manner as in the treatment period 400 by executing the treatment period 300 with the first reverse osmosis membrane device and the third reverse osmosis membrane device swapped again before the water recovery ratio decreases due to the scale clogging. Scale clogging in the first and third reverse osmosis membrane devices can be prevented from progressing over a long period in this manner, and pure water can thus be stably and efficiently produced over a long period. Furthermore, since the acid and alkali conditions employed in the step 301 (step 401) and the step 302 (step 402) are acid and alkali conditions milder than chemicals generally used for scale cleaning, deterioration of the reverse osmosis membranes can also be suppressed, and pure water with high water quality can be stably produced over a long period as a result.

Incidentally, specific scale components are silica, aluminum, and the like in addition to the hardness component such as calcium (Ca) compounds such as calcium carbonate, calcium fluoride, calcium hydroxide, calcium sulfate, and calcium phosphate, and magnesium (Mg) compounds such as magnesium carbonate, magnesium fluoride, magnesium hydroxide, magnesium sulfate, and magnesium phosphate, which are primarily insoluble in water, and scale clogging is a phenomenon in which these scale components attach to a membrane surface to partially or entirely clog the membrane, resulting in a reduction in the amount of permeate water. In addition, scale clogging due to the hardness component is likely to occur under alkaline conditions, and scale clogging due to silica is likely to occur under acidic conditions.

In the first embodiment and the second embodiment, the timing for swapping the reverse osmosis membrane devices can be determined through measurement of the treated water flow rate at the most downstream point, and the reverse osmosis membrane devices can be swapped when the treated water flow rate decreases to a predetermined ratio from an initial flow rate, for example. A period until the treated water flow rate at the most downstream point decreases to a predetermined from the initial flow rate may be calculated in advance, considering the water recovery ratio, and the swapping may be carried out at each end of the period. In addition, the pressures of the feed water and permeate water of each reverse osmosis membrane device may be measured, and the swapping may be carried out when the difference therebetween reaches a predetermined value, and a period until the difference in pressure between the feed water and permeate water of the reverse osmosis membrane device reaches a predetermined value may be calculated in advance, considering the water recovery ratio, and the swapping may be carried out at each end of the period. In addition, a differential pressure at which irreversible membrane deterioration occurs may be determined through a preliminary experiment, and the swapping may be carried out before reaching the differential pressure.

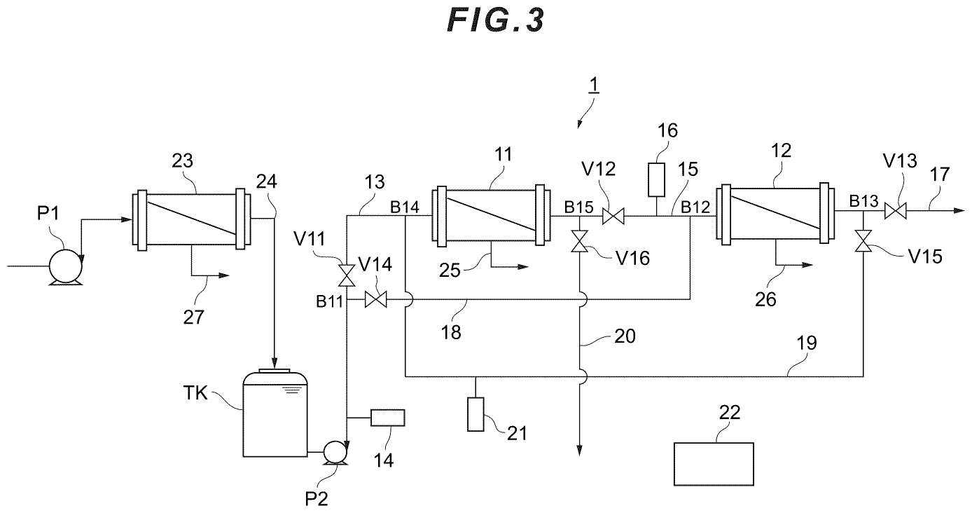

Next, a pure water production device that realizes the pure water production method of the first embodiment will be described with reference to FIG. 3. FIG. 3 is a block diagram schematically illustrating a pure water production device 1 of a third embodiment. The pure water production device 1 of the third embodiment has two reverse osmosis membrane devices (a reverse osmosis membrane device 11 and a reverse osmosis membrane device 12) connected in series. The pure water production device 1 further includes a feed pipe 13 that is connected to the feed side of the reverse osmosis membrane device 11 and feeds water to be treated to the reverse osmosis membrane device 11, and an alkali adjustment mechanism 14 that is provided in a pathway of the feed pipe 13 and adjusts the water to be treated of the reverse osmosis membrane device 11 to be alkaline. The pure water production device 1 further includes a feed pipe 15 that connects the permeation side of the reverse osmosis membrane device 11 and the feed side of the reverse osmosis membrane device 12 and feeds the permeated water of the reverse osmosis membrane device 11 to the feed side of the reverse osmosis membrane device 12, and an acid adjustment mechanism 16 that is provided in a pathway of the feed pipe 15 and adjusts the water to be treated of the reverse osmosis membrane device 12 to be acidic. A feed pipe 17 is connected to the permeation side of the reverse osmosis membrane device 12, and pure water produced in the pure water production device 1 is sent to a subsequent stage via the feed pipe 17.

Each of the reverse osmosis membrane devices 11 and 12 includes, for example, one or more reverse osmosis membrane modules, each reverse osmosis membrane module configured such that a reverse osmosis membrane and a flow path material for passing water to be treated through the reverse osmosis membrane are housed in a casing. As the reverse osmosis membrane, various organic polymer membranes formed from cellulose acetate, an aliphatic polyamide-based or aromatic polyamide-based material, or a composite material thereof, or a ceramic membrane can be used, for example. The reverse osmosis membrane has a hollow fiber shape, a spiral shape, a flat plate shape, a tube shape, or the like. The reverse osmosis membrane of the present embodiment preferably has a spiral shape from the point of increasing pressure resistance and enhancing the treatment efficiency. In addition, the reverse osmosis membrane devices 11 and 12 are ultra-low pressure type, low pressure type, medium pressure type, or high pressure type reverse osmosis membrane devices, and the two reverse osmosis membrane devices are of the same type. For example, when the reverse osmosis membrane device 11 is an ultra-low pressure type reverse osmosis membrane device, the reverse osmosis membrane device 12 is also an ultra-low pressure type reverse osmosis membrane device, when the reverse osmosis membrane device 11 is a low pressure type reverse osmosis membrane device, the reverse osmosis membrane device 12 is also a low pressure type reverse osmosis membrane device, when the reverse osmosis membrane device 11 is a medium pressure type reverse osmosis membrane device, the reverse osmosis membrane device 12 is also a medium pressure type reverse osmosis membrane device, and when the reverse osmosis membrane device 11 is a high pressure type reverse osmosis membrane device, the reverse osmosis membrane device 12 is also a high pressure type reverse osmosis membrane device.

The alkali adjustment mechanism 14 and the acid adjustment mechanisms 16 and 21 each include, for example, a tank that stores an acid adjusting agent or an alkali adjusting agent, and a chemical dispensing pump that meters a predetermined amount of a chemical agent in the tank and adds the chemical agent into each feed pipe.

A feed pipe 18 is connected to a branch point B11 of the feed pipe 13 on the downstream side of the alkali adjustment mechanism 14. Another branch point B14 is located downstream of the branch point B11. The end of the feed pipe 18 opposite to the connection to the branch point B11 is connected to the feed pipe 15 at a branch point B12 located on the downstream side of the acid adjustment mechanism 16 of the feed pipe 15. The water to be treated, which has been adjusted to be alkaline by the alkali adjustment mechanism 14, is fed to the feed side of the reverse osmosis membrane device 12 via the feed pipe 18 through the branch point B11.

A feed pipe 19 is connected to a branch point B13 located in a pathway of the feed pipe 17. The end of the feed pipe 19 opposite to the connection to the branch point B13 is connected to the feed pipe 13 at the branch point B14. The permeate water of the reverse osmosis membrane device 12 passes through the feed pipe 19 from the feed pipe 17 through the branch point B13, and is fed to the feed side of the reverse osmosis membrane device 11 from the branch point B14 via a pathway on the downstream side of the feed pipe 13. An acid adjustment mechanism 21 that adjusts the permeate water of the reverse osmosis membrane device 12 to be acidic is provided in a pathway of the feed pipe 19. A feed pipe 20 is connected to a branch point B15 of the feed pipe 15 on the permeation side of the reverse osmosis membrane device 11, and pure water produced in the pure water production device 1 is sent to a subsequent stage via the feed pipe 20.

In the pure water production device 1, a flow path which is composed of the feed pipe 13, the reverse osmosis membrane device 11, the feed pipe 15, the reverse osmosis membrane device 12, and the feed pipe 17 and in which the water to be treated is treated by the reverse osmosis membrane device 11 and the reverse osmosis membrane device 12 in this order is a first treatment pathway. In addition, a flow path in which the water to be treated is treated by the reverse osmosis membrane device 12 and the reverse osmosis membrane device 11 in this order through the feed pipe 18 from the pathway on the upstream side of the branch point B11 of the feed pipe 13, the pathway on the downstream side of the branch point B12 of the feed pipe 15, the reverse osmosis membrane device 12, the pathway on the upstream side of the branch point B13 of the feed pipe 17, and the feed pipe 19, and further through the pathway on the downstream side of the branch point B14 of the feed pipe 13 is a second treatment pathway.

In the pure water production device 1, valves V11 to V16 are interposed into the pathways of the feed pipes 13, 15, 17, 18, 19, and 20, respectively, so that the first treatment pathway and the second treatment pathway can be switched. These valves V11 to V16 function as a switching mechanism. For example, the valve V11 is interposed between the branch point B11 and the branch point B14 of the pathway of the feed pipe 13, and the valve V14 is interposed on the downstream side of the pathway of the feed pipe 18 in the vicinity of the branch point B11. The valve V12 is interposed on the upstream side (the reverse osmosis membrane device 11 side) of the branch point B12 and on the downstream side (the reverse osmosis membrane device 12 side) of the branch point B15 in the pathway of the feed pipe 15, and the valve V16 is interposed into a pathway of the feed pipe 20. The valve V13 is interposed on the downstream side of the branch point B13 of the pathway of the feed pipe 17, and the valve V15 is interposed on the downstream side of the branch point B13 of the pathway of the feed pipe 19 and on the upstream side (the reverse osmosis membrane device 12 side) of the acid adjustment mechanism 21. The valves V11 to V16 are, for example, on-off valves that can be opened and closed, and may be automatic on-off valves, with opening and closing thereof automatically controlled by receiving control signals output from a control device 22. In addition, two valves provided at a branch, for example, the valve V11 and the valve V14, the valve V12 and the valve V16, and the valve V13 and the valve V15 may be combined and replaced with a single three-way valve to provide a similar switching function.

The pure water production device 1 arbitrary includes, in a stage preceding the feed pipe 13, a pump P1, a reverse osmosis membrane device 23, a tank TK, a pump P2, and a feed pipe 24 that connects the pump P1, the reverse osmosis membrane device 23, the tank TK, and the pump P2 to send raw water from the pump P1 to the feed pipe 13 through the reverse osmosis membrane device 23 and the tank TK. The most downstream side of the feed pipe 24 is connected to the feed pipe 13 via the pump P2. A preferable configuration of the reverse osmosis membrane device 23 is the same as that of the reverse osmosis membrane devices 11 and 12. In addition, the reverse osmosis membrane device 23 is an ultra-low pressure type, low pressure type, or high pressure type reverse osmosis membrane device, and is preferably of the same type as the reverse osmosis membrane devices 11 and 12. The pumps P1 and P2 are, for example, water feed pumps the ejection pressure of which can be adjusted.

The reverse osmosis membrane devices 11, 12, and 23 may be further provided, on the feed side and the permeation side thereof, with a water pressure gauge that measures the water pressure of the water to be treated or the permeate water. Further, in addition to the water pressure gauge or instead of the water pressure gauge, a flowmeter that measures the flow rate of the water to be treated or the permeate water may be provided.

Discharge pipes 25 and 26 for concentrated water are connected to the concentration sides of the reverse osmosis membrane device 11 and the reverse osmosis membrane device 12, respectively. The concentrated water can be discharged to the outside of the system of the pure water production device 1 via the discharge pipes 25 and 26, or can be returned to the preceding stage of the reverse osmosis membrane device 23 and treated again. A discharge pipe 27 for concentrated water is connected to the concentration side of the reverse osmosis membrane device 23, and the concentrated water of the reverse osmosis membrane device 23 is discharged to the outside of the system of the pure water production device 1 via the discharge pipe 27.

The pure water production device 1 includes the control device 22 that controls opening and closing of the valves V11 to V16 in accordance with a program input in advance. Hereinafter, a method for switching the first treatment period and the second treatment period using the control device 22 will be described.

First, the control device 22 outputs a control signal to open the valves V11, V12, and V13 and close the valves V14, V15, and V16. As a result, the first treatment pathway is opened. Raw water is fed from a raw water tank (not shown) to the reverse osmosis membrane device 23 by the pump P1. The raw water is, for example, city water, well water, industrial water, or the like. In addition, the raw water may be used and recovered water that has been used at an ultrapure water usage site, recovered therefrom, and subsequently subjected to a chemical removal treatment or the like as necessary. For example, raw water includes, as ions which may form an inorganic salt insoluble in water to generate a scale component, a hardness component such as calcium and magnesium and dissolved carbon dioxide gas in an amount of 10 mg/L to 300 mg/L in total in terms of calcium carbonate. In addition, the raw water includes, for example, about 1 mg/L to 50 mg/L of silica (Si), about 0.1 mg/L to 0.6 mg/L of chlorine in terms of Cl, and about 5 μg/L to 100 μg/L of boron. The pH of the raw water is about 5 to 7.5.

The feed pressure of the raw water to the reverse osmosis membrane device 23 is, for example, 0.4 MPa to 8.0 MPa and is preferably 0.5 MPa to 3.0 MPa. The raw water is subjected to a reverse osmosis membrane treatment in the reverse osmosis membrane device 23, and the hardness component in the raw water is removed (the step 101 in FIG. 1) thereby. An acid adjustment mechanism may be provided on the upstream side of the reverse osmosis membrane device 23 in the feed pipe 24, and the raw water may be adjusted to be acidic and then treated by the reverse osmosis membrane device 23. In this case, the pH of the raw water having been adjusted to be acidic is preferably 5.0 or higher and 6.0 or lower, and the removal ratio of the hardness component in the raw water can thus be improved.

The permeate water of the reverse osmosis membrane device 23 is temporarily stored in the tank TK. The permeate water stored in the tank TK is fed as water to be treated to the reverse osmosis membrane device 11 via the feed pipe 13 in the first treatment pathway by the pump P2. In the process in which the water to be treated passes through the feed pipe 13, an alkali adjusting agent is added to the water to be treated by the alkali adjustment mechanism 14, and the water to be treated is thus adjusted to be alkaline. Examples of the alkali adjusting agent include an aqueous potassium hydroxide solution and an aqueous sodium hydroxide solution, and an aqueous sodium hydroxide solution is generally used. In addition, the pH of the permeate water having been adjusted to be alkaline is 9.0 or higher and 11.0 or lower and more preferably 9.2 or higher and 10.5 or lower in order to improve the boron removal ratio in the reverse osmosis membrane device 11.

The water to be treated is treated by the reverse osmosis membrane device 11, and not only boron but also silica, carbonate ions, and anions in the water to be treated are removed (the step 102 in FIG. 1). The permeate water of the reverse osmosis membrane device 11 from which boron has been removed has an electric conductivity of, for example, 1 μS/cm to 15 μS/cm and a boron concentration of, for example, 0.3 ppb (μg/L) to 10 ppb (μg/L), and the boron removal ratio in the reverse osmosis membrane device 11 is 50% to 95%. The permeate water of the reverse osmosis membrane device 11 from which boron has been removed is then fed as water to be treated to the feed side of the reverse osmosis membrane device 12 via the feed pipe 15 in the first treatment pathway. In the process in which the water to be treated passes through the feed pipe 15, an acid adjusting agent is added to the water to be treated by the acid adjustment mechanism 16, and the water to be treated is thus adjusted to be acidic. Examples of the acid adjusting agent include an aqueous hydrochloric acid solution and an aqueous sulfuric acid solution, and an aqueous sulfuric acid solution is generally used. The pH of the permeate water having been adjusted to be acidic is preferably 5.0 or lower and more preferably 4.5 or lower, and preferably 2.0 or higher and more preferably 3.0 or higher in order to improve the removal ratio of the ion component in the reverse osmosis membrane device 12. The pH of the permeate water is preferably 2.0 or higher and 5.0 or lower, and more preferably 3.0 or higher and 4.5 or lower

The water to be treated is treated by the reverse osmosis membrane device 12, and the ion component in the water to be treated is removed (the step 103 in FIG. 1). The ion component removed by the reverse osmosis membrane device 12 is mainly an anion component such as chloride ions, sulfate ions, nitrate ions, fluoride ions, and ionized bicarbonate ions, a cation component such as sodium ions and potassium ions, and a weak electrolyte such as silica. The permeate water of the reverse osmosis membrane device 12 from which the ion component is removed has a specific resistance (resistivity) of, for example, 0.5 MΩ·cm to 10 MΩ·cm and a boron concentration of, for example, 0.1 ppb (μg/L) to 5 ppb (μg/L). The permeate water of the reverse osmosis membrane device 12 is sent to a subsequent stage via the feed pipe 17. The concentrated water of the reverse osmosis membrane device 11 and the reverse osmosis membrane device 12 is discharged to the outside of the system of the pure water production device 1, or is returned to the preceding stage side of the reverse osmosis membrane device 23 and treated again.

As described above, the water to be treated in the tank TK passes through the reverse osmosis membrane device 11 and the reverse osmosis membrane device 12 in this order via the first treatment pathway and treated. A predetermined period during which this treatment is performed is the first treatment period. After the first treatment period, the control device 22 outputs a control signal to close the valves V11, V12, and V13 and to open the valves V14, V15, and V16. The second treatment pathway is thereby opened, and the second treatment period starts.

In the second treatment period, the water to be treated stored in the tank TK is fed, by the pump P2, to the reverse osmosis membrane device 12 from the branch point B11 of the feed pipe 13 in the second treatment pathway via the feed pipe 18. In the process in which the water to be treated passes through the feed pipe 13, an alkali adjusting agent is added to the water to be treated by the alkali adjustment mechanism 14, and the water to be treated is thus adjusted to be alkaline. Preferred embodiments regarding the type of the alkali adjusting agent and the pH of the water to be treated are the same as those in the first treatment period.

The water to be treated is treated by the reverse osmosis membrane device 12 (the step 202 in FIG. 1), and boron, silica, carbonate ions, and anions in the water to be treated are removed in the same manner as in the first treatment period. The water quality of the permeate water of the reverse osmosis membrane device 11 from which boron has been removed is the same as that in the first treatment period.

The permeate water of the reverse osmosis membrane device 12 then passes, from the branch point B13 of the feed pipe 17 in the second treatment pathway, sequentially through the feed pipe 19 and the downstream side of the branch point B14 of the feed pipe 13, and is fed to the feed side of the reverse osmosis membrane device 11 as the water to be treated. In the process in which the water to be treated passes through the feed pipe 19, an acid adjusting agent is added to the water to be treated by the acid adjustment mechanism 16, and the water to be treated is thus adjusted to be acidic. Preferred embodiments regarding the type of the acid adjusting agent and the pH of the water to be treated are the same as those in the first treatment period.

The water to be treated is treated by the reverse osmosis membrane device 11, and the ion component in the water to be treated is removed in the same manner as in the first treatment period (the step 203 in FIG. 1). The water quality of the permeate water of the reverse osmosis membrane device 11 from which the ion component has been removed is also the same as that in the first treatment period. The permeate water of the reverse osmosis membrane device 11 is sent to a subsequent stage via the feed pipe 15, the branch point B15, and the feed pipe 20 in this order. The concentrated water of each of the reverse osmosis membrane device 11 and the reverse osmosis membrane device 12 is discharged to the outside of the system of the pure water production device 1, or is returned to the preceding stage side of the reverse osmosis membrane device 23 and treated again.

As described above, in the second treatment period, the water to be treated in the tank TK is passed through the reverse osmosis membrane device 12 and the reverse osmosis membrane device 11 in this order via the second treatment pathway and treated. After the second treatment period, the control device 22 outputs a control signal to open the valves V11, V12, and V13 and close the valves V14, V15, and V16. Consequently, the first treatment pathway is opened, and the first treatment period resumes. By repeating these processes, the first treatment period and the second treatment period are alternately repeated.

In the pure water production device 1 of the present embodiment, although the hardness component is removed in the reverse osmosis membrane device 11 in the first treatment period, a hardness component leaks into the permeate water of the reverse osmosis membrane device depending on the water quality or the operation period, and scale clogging in the reverse osmosis membrane device 11 may progress. In addition, in the second reverse osmosis membrane device which treats the acidic water to be treated, scale clogging due to silica is likely to progress. Therefore, before scale clogging in the reverse osmosis membrane devices 11 and 12 deteriorates the water recovery ratio, the order of the reverse osmosis membrane device 11 and the reverse osmosis membrane device 12 is changed, and the second treatment period is executed. In the second treatment period, the reverse osmosis membrane device 11 treats the water to be treated having been adjusted to be acidic, and the hardness component is dissolved in an acid, and the scale clogging is ameliorated during this process. In addition, in the second reverse osmosis membrane device 12 in which scale clogging due to silica has progressed, the silica scale is dissolved in an alkali by treating the water to be treated having been adjusted to be alkaline, and the scale clogging is ameliorated. In the second treatment period, scale clogging in the reverse osmosis membrane device 12 arranged on the preceding stage side may progress in the same manner as described above. However, by interchanging the flow order of the water to be treated through the reverse osmosis membrane device 11 and the reverse osmosis membrane device 12 and executing the first treatment period before the water recovery ratio decreases due to the scale clogging, the scale clogging in the reverse osmosis membrane devices 11 and 12 is ameliorated in the same manner as in the second treatment period. Consequently, progress of scale clogging in the reverse osmosis membrane devices 11 and 12 can be suppressed over a long period, and pure water can thus be stably and efficiently produced over a long period. Furthermore, since the acid and alkali conditions employed in the pure water production device 1 are acid and alkali conditions milder than chemicals generally used for scale cleaning, deterioration of the reverse osmosis membranes can also be suppressed, and pure water with high water quality can be stably produced over a long period as a result.

The timing for switching the first treatment period and the second treatment period can be determined as follows. A first switching method is a method in which the treated water flow rate at the most downstream point is measured, and the switching is carried out when the treated water flow rate decreases to a predetermined ratio from an initial flow rate. Specifically, the switching can be carried out as follows. A flowmeter is connected to the most downstream side of a pipe, an arithmetic unit is provided in the control device 22, and the flowmeter inputs a measurement value to the arithmetic unit. The place where the flowmeter is disposed is, for example, the vicinity of an end of each of the feed pipe 17 and the feed pipe 20, the vicinity of the connection between the feed pipe 17 and the feed side of the second reverse osmosis membrane device 12, and the vicinity of the connection between the feed pipe 20 and the permeation side of the first reverse osmosis membrane device. The arithmetic unit calculates the decreasing ratio of the flow rate from the flow rate at the beginning of water passage, and when the calculated decreasing ratio of the flow rate exceeds a preliminarily determined threshold value, the control device 22 outputs a control signal for controlling the switching mechanism to open and close valves. For example, when the initial flow rate is taken as 1, the threshold value of the decreasing ratio of the flow rate at the time of switching in a first switching method is set to a predetermined value in the range of 0.05 or more and 0.5 or less, that is, in the range of the flow rate of 50% or more and 95% or less with respect to the initial flow rate taken as 100%, whereby the reverse osmosis membrane treatment can be continued over a long period without conducting scale cleaning of the reverse osmosis membrane devices 11 and 12. The threshold value of the decreasing ratio of the flow rate at the time of switching is preferably set to a value in the range of 0.05 or more and 0.2 or less when the initial flow rate is taken as 1, that is, in the range of the flow rate of 80% or more and 95% or less with respect to the initial flow rate taken as 100%, whereby deterioration of the membranes can be suppressed, and the reverse osmosis membrane treatment can be continued with stable water quality. A period until the treated water flow rate at the most downstream point decreases to a predetermined ratio from the initial flow rate may be calculated in advance, considering the water recovery ratio, and the swapping may be carried out at each end of the period.

The second switching method is a method in which a water pressure gauge is arranged on each of the feed side and the permeation side of each of the reverse osmosis membrane device 11 and the reverse osmosis membrane device 12, and when the differential pressure between the water fed to the reverse osmosis membrane device 11 and the permeate water of the reverse osmosis membrane device 12 becomes a predetermined value in the first treatment period and when the differential pressure between the water fed to the reverse osmosis membrane device 12 and the permeate water of the reverse osmosis membrane device 11 becomes a predetermined value in the second treatment period, the control device switches the first treatment pathway and the second treatment pathway. This method can also be executed as follows in the same manner as in the first switching method described above. An arithmetic unit is provided in the control device 22, each water pressure gauge inputs a measurement value to the arithmetic unit, and the arithmetic unit calculates the differential pressure. When the calculated differential pressure exceeds a preliminarily determined threshold value, the control device 22 outputs a control signal for controlling the switching mechanism to open and close valves. The threshold value of the differential pressure at the time of switching in the second switching method is preferably, for example, a predetermined value in the range of 105% or more and 200% or less, and more preferably a predetermined value in the range of 105% or more and 125% or less, with respect to the water passage differential pressure of at the beginning of water passage. Consequently, the reverse osmosis membrane treatment can be continued over a long period without conducting scale cleaning of the reverse osmosis membrane devices 11 and 12. The water passage differential pressure is a value of a difference obtained by subtracting an average value of the feed water pressure and the concentrated water pressure from the permeate water pressure.

A third switching method is a method in which the duration of each of the first treatment period and the second treatment period is determined in advance in consideration of the quality of raw water, the amount of the alkali adjusting agent added by the alkali adjustment mechanism 14, the amount of the acid adjusting agent added by the acid adjustment mechanisms 16 and 21, the specifications of the reverse osmosis membrane devices 11 and 12, and the water recovery ratio, and the control device 22 controls the switching mechanism in accordance with the duration. This case is executed as follows. The control device 22 is provided with a timer unit that measures time and outputs a switching signal at a preset time. When the timer unit outputs a switching signal at a preset time, the switching signal is input to the control device 22. When the switching signal is input, the control device 22 outputs a control signal to control the switching mechanism (valves V11 to V16). The duration of each of the first treatment period and the second treatment period may be determined on the basis of a scale clogging progress rate examined through a preliminary experiment.

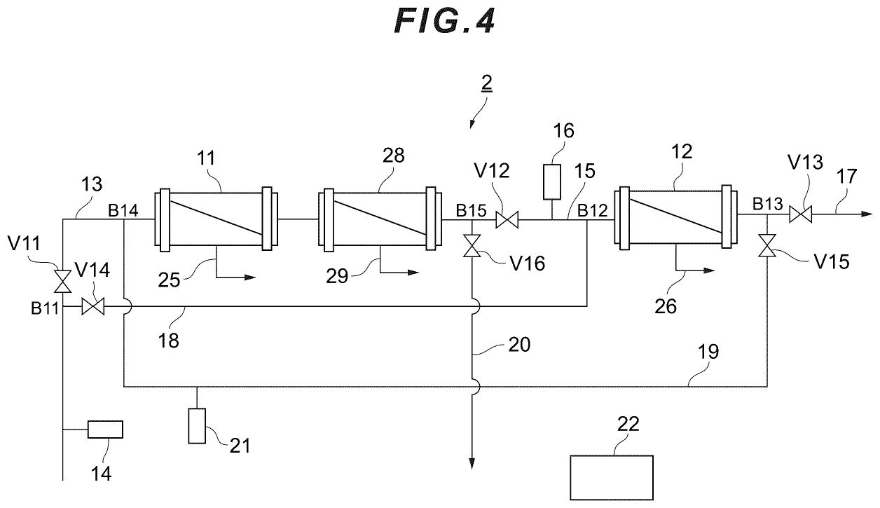

Next, a pure water production device 2 which is a first modification of the pure water production device 1 of the third embodiment will be described with reference to FIG. 4. FIG. 4 is a block diagram schematically illustrating the pure water production device 2 of the present modification. The pure water production device 2 is different from the pure water production device 1 in the point that a reverse osmosis membrane device 28 is further provided between two reverse osmosis membrane devices (a reverse osmosis membrane device 11 and a reverse osmosis membrane device 12) connected in series. In FIG. 4, components providing the same functions as those in FIG. 3 are denoted by the same reference numerals, and detailed description thereof is omitted. In addition, an arbitrary component is partially omitted in the illustration of FIG. 4.

The reverse osmosis membrane device 28 is interposed, for example, on the upstream side (the reverse osmosis membrane device 11 side) of a branch point B15 of a feed pipe 15. A concentrated water discharge pipe 29 is provided on the concentration side of the reverse osmosis membrane device 28, and the concentrated water is discharged to the outside of the system of the pure water production device 2 via the discharge pipe 29 or is returned to the preceding stage of the reverse osmosis membrane device 23 and treated again. The reverse osmosis membrane device 28 is an ultra-low pressure type, low pressure type, or high pressure type reverse osmosis membrane device, and may be the same as or different from the reverse osmosis membrane devices 11 and 12 or the reverse osmosis membrane device 23 illustrated in FIG. 3. The reverse osmosis membrane device 28 may be provided, on the feed side and the permeation side thereof, with a water pressure gauge that measures the water pressure of the water to be treated or the permeate water. Further, in addition to the water pressure gauge or instead of the water pressure gauge, a flowmeter that measures the flow rate of the water to be treated or the permeate water may be provided.

In the pure water production device 2, in a first treatment period, the water to be treated is passed through a first treatment pathway, that is, a feed pipe 13, the reverse osmosis membrane device 11, the reverse osmosis membrane device 28, the feed pipe 15, and the reverse osmosis membrane device 12 in this order, and is treated. In the first treatment period, the permeate water of the reverse osmosis membrane device 28 has an electric conductivity of, for example, 1 μS/cm to 15 μS/cm and a boron concentration of, for example, 0.1 ppb (μg/L) to 5 ppb (μg/L), and the permeate water of the reverse osmosis membrane device 12 has a resistivity of, for example, 0.5 MΩ to 10 MΩ and a boron concentration of, for example, 0.1 ppb (μg/L) to 3 ppb (μg/L). As described above, by providing the reverse osmosis membrane device 28, the removal ratios of boron and silica of pure water to be produced can be increased, and a boron removal ratio of 60% to 98% can be achieved in the pure water production device 2.

In the pure water production device 2, in the second treatment period, the water to be treated is passed through a second treatment pathway, that is, the upstream side of a branch point B11 of the feed pipe 13, the branch point B11, a feed pipe 18, a branch point B12, the reverse osmosis membrane device 12, the upstream side of a branch point B13 of a feed pipe 17, a feed pipe 19, the downstream side of a branch point B14 of the feed pipe 13, the reverse osmosis membrane device 11, the feed pipe 15, the reverse osmosis membrane device 28, and a feed pipe 20 in this order and treated. The water quality of the permeate water of the reverse osmosis membrane device 11 in the second treatment period is the same as that in the first treatment period.

Also in the pure water production device 2, by repeating switching between the first treatment period and the second treatment period in the same manner as in the pure water production device 1 described above, production of pure water cane be stably continued over a long period without conducting scale cleaning of the reverse osmosis membrane devices 11 and 12.

In addition, as a second modification of the pure water production device 1, the water passage order may be configured to be interchanged between the reverse osmosis membrane device 23 and the reverse osmosis membrane device 11. In this modification, a first treatment period in which the reverse osmosis membrane device 23 is used in the preceding stage and the reverse osmosis membrane device 11 is used in the subsequent stage and a second treatment period in which the reverse osmosis membrane device 11 is used in the preceding stage and the reverse osmosis membrane device 23 is used in the subsequent stage can be repeated. In this modification, a switching mechanism is disposed by disposing pipes and valves in the same manner as in the pure water production device 1 of the above-described embodiment, and a first treatment pathway in which raw water is passed through the reverse osmosis membrane device 23, the alkali adjustment mechanism 14, and the reverse osmosis membrane device 11 in this order and a second treatment pathway in which raw water is passed through the reverse osmosis membrane device 11, the alkali adjustment mechanism 14, and the reverse osmosis membrane device 23 in this order are configured. Consequently, the control device 22 can alternately repeat the first treatment period using the first treatment pathway and the second treatment period using the second treatment pathway by controlling the switching mechanism to switch the first treatment pathway and the second treatment pathway at each end of a predetermined treatment period. Further, in this modification, the reverse osmosis membrane device 23 is an ultra-low pressure type, low pressure type, or high pressure type reverse osmosis membrane device, and is of the same type as the reverse osmosis membrane device 11. An acid adjustment mechanism may be provided immediately after the pump P1 in a pathway of the feed pipe 24, and the water to be treated may be adjusted to be acidic and fed to the reverse osmosis membrane device of the first stage. Consequently, the removal ratio of the hardness component in the reverse osmosis membrane device of the first stage can be improved. The acid adjusting agent in this case is the same as that described above, but the pH of the water to be treated is preferably adjusted to 5.0 to 6.0.

In this modification, although the hardness component is removed in the reverse osmosis membrane device 23 in the first treatment period, the hardness component may leak into the permeate water of the reverse osmosis membrane device 23 depending on the water quality or the operation period, and scale clogging in the reverse osmosis membrane device 11 in the subsequent stage may progress. In addition, in the reverse osmosis membrane device 23 that treats weakly acidic water to be treated, scale clogging due to silica is likely to progress. Therefore, before scale clogging in the reverse osmosis membrane device 11 and the reverse osmosis membrane device 23 deteriorates the water recovery ratio, the water passage order is interchanged between the reverse osmosis membrane device 11 and the reverse osmosis membrane device 23, and the second treatment period is executed. In the second treatment period, the reverse osmosis membrane device 11 treats the water to be treated having been adjusted to be weakly acidic, and the hardness scale is dissolved in an acid, and the scale clogging is ameliorated during this process. In addition, in the reverse osmosis membrane device 23 in which the scale clogging due to silica has progressed, the silica scale is dissolved in an alkali by treating the water to be treated having been adjusted to be alkaline, and the scale clogging is ameliorated. In the second treatment period, silica scale clogging in the reverse osmosis membrane device 23 for treating alkaline water to be treated and hardness scale clogging in the reverse osmosis membrane device 11 for treating weakly acidic water to be treated may progress; however, scale clogging of the reverse osmosis membrane devices 11 and 23 is ameliorated in the same manner as in the second treatment period by swapping the reverse osmosis membrane device 11 and the reverse osmosis membrane device 23 and executing the first treatment period again before the water recovery ratio decreases due to the scale clogging. Consequently, progress of scale clogging in the reverse osmosis membrane devices 23 and 11 can be suppressed over a long period, and pure water can thus be stably and efficiently produced over a long period. Furthermore, since the acid and alkali conditions employed in this modification are acid and alkali conditions milder than chemicals generally used for scale cleaning, deterioration of the reverse osmosis membranes can also be suppressed, and pure water with high water quality can be stably produced over a long period as a result.

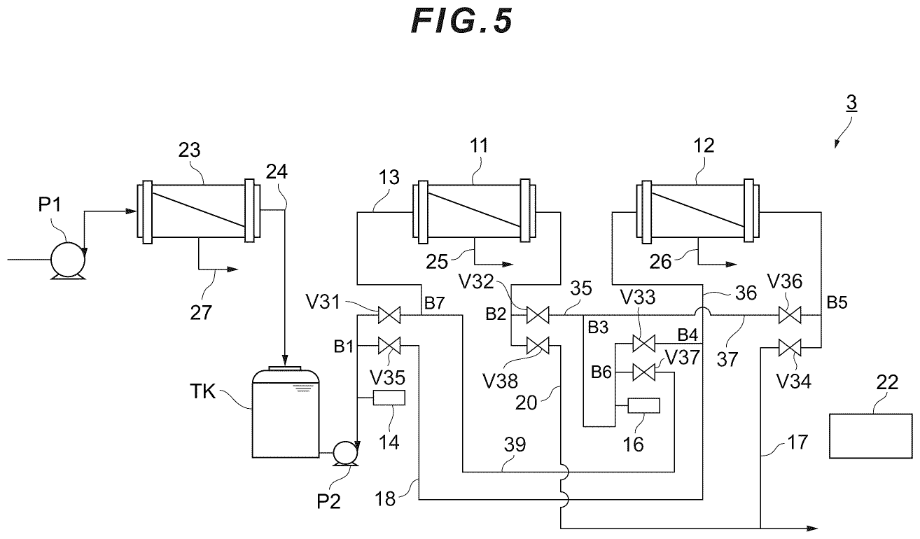

Next, a pure water production device 3 of a fourth embodiment will be described with reference to FIG. 5. FIG. 5 is a block diagram schematically illustrating the pure water production device 3 of the fourth embodiment. The pure water production device 3 illustrated in FIG. 5 is different from the pure water production device 1 in the point that the acid adjustment mechanism is integrated at one location. As a result, an installation configuration of pipes (feed pipes) and valves is also different. Therefore, a piping method of the pure water production device 3 will be mainly described below. In addition, in FIG. 5, components providing the same functions as those in FIG. 3 are denoted by the same reference numerals, and detailed description thereof is omitted, and descriptions of the same method and effect as those of the pure water production device 1 illustrated in FIG. 3 are also partially omitted.

The pure water production device 3 of the fourth embodiment has two reverse osmosis membrane devices (a reverse osmosis membrane device 11 and a reverse osmosis membrane device 12) connected in series in the same manner as in the pure water production device 1 of the third embodiment. The pure water production device 1 further includes a feed pipe 13 that is connected to the feed side of the reverse osmosis membrane device 11 and feeds water to be treated to the reverse osmosis membrane device 11, and an alkali adjustment mechanism 14 that is provided in a pathway of the feed pipe 13 and adjusts the water to be treated of the reverse osmosis membrane device 11 to be alkaline. A pump P2 is arranged at the end of the feed pipe 13 opposite to the connection to the reverse osmosis membrane device 11, and the water to be treated is sent from a tank TK to the reverse osmosis membrane device 11 by the pump P2. The feed pipe 13 has two branch points, that is, branch points B1 and B7 in order from the upstream side in the pathway of the feed pipe 13. Further, a valve V31 is interposed between the branch point B1 and the branch point B7 in the pathway of the feed pipe 13.

The pure water production device 3 further includes a feed pipe 35 that is connected to the permeation side of the reverse osmosis membrane device 11 and sends the water to be treated to a subsequent stage. Branch points B2, B3, B6, and B4 are located in order from the upstream side (the permeation side of the reverse osmosis membrane device 11) in a pathway of the feed pipe 35. An acid adjustment mechanism 16 that adjusts the water to be treated of the reverse osmosis membrane device 12 to be acidic is provided between the branch point B3 and the branch point B6 of the pathway of the feed pipe 35. A valve V32 is interposed between the branch point B2 and the branch point B3 of the feed pipe 35, and a valve V33 is interposed between the branch points B6 and B4.

A feed pipe 36 is connected to the branch point B4 of the feed pipe 35. The end of the feed pipe 36 opposite to the branch point B4 is connected to the feed side of the reverse osmosis membrane device 12. Consequently, the water to be treated having been adjusted to be acidic by the acid adjustment mechanism 16 is fed from the feed side of the reverse osmosis membrane device 12 via the feed pipe 36.

A feed pipe 18 is connected to the branch point B1 of the feed pipe 13 between the alkali adjustment mechanism 14 and the valve V31. The water to be treated having been adjusted to be alkaline by the alkali adjustment mechanism 14 is sent to the feed pipe 18 through the branch point B1. The feed pipe 18 is connected to the feed pipe 36 at the branch point B4, and the water to be treated is fed to the feed side of the reverse osmosis membrane device 12 through the feed pipe 13, the branch point B1, the feed pipe 18, the branch point B4, and the feed pipe 36 in this order. The pure water production device 3 further includes a feed pipe 37 connected between a branch point B5 of a feed pipe 17 and the branch point B3 of the feed pipe 35. A valve V36 is interposed into the feed pipe 37. The pure water production device 3 includes a feed pipe 39 connected between the branch point B6 of the feed pipe 35 and the feed pipe 13. A valve V37 is interposed into the feed pipe 39. The feed pipe 17 is connected to the feed pipe 37 at the branch point B5, and pure water produced by the pure water production device 1 is sent to a subsequent stage via the feed pipe 17. A valve V34 is interposed into a pathway of the feed pipe 17.

The permeate water of the reverse osmosis membrane device 12 is adjusted to be acidic by the acid adjustment mechanism 16 provided in a pathway of the feed pipe 35 in the process of passing through the feed pipe 17, the branch point B5, the feed pipe 37, the branch point B3, and the feed pipe 35 in this order. Thereafter, the water to be treated having been adjusted to be acidic is passed through the branch point B6, the feed pipe 39, and the branch point B7 to the feed pipe 13, and is then fed to the feed side of the first reverse osmosis membrane device 11. A feed pipe 20 is connected to the feed pipe 35 connected to the permeation side of the reverse osmosis membrane device 11 at the branch point B2, and pure water produced by the pure water production device 1 is sent to a subsequent stage via the feed pipe 20. A valve V38 is interposed into a pathway of the feed pipe 20.

Preferred configurations of the valves V31 to V38 and the pumps P1 and P2 are the same as those of the pure water production device 1 of the third embodiment.

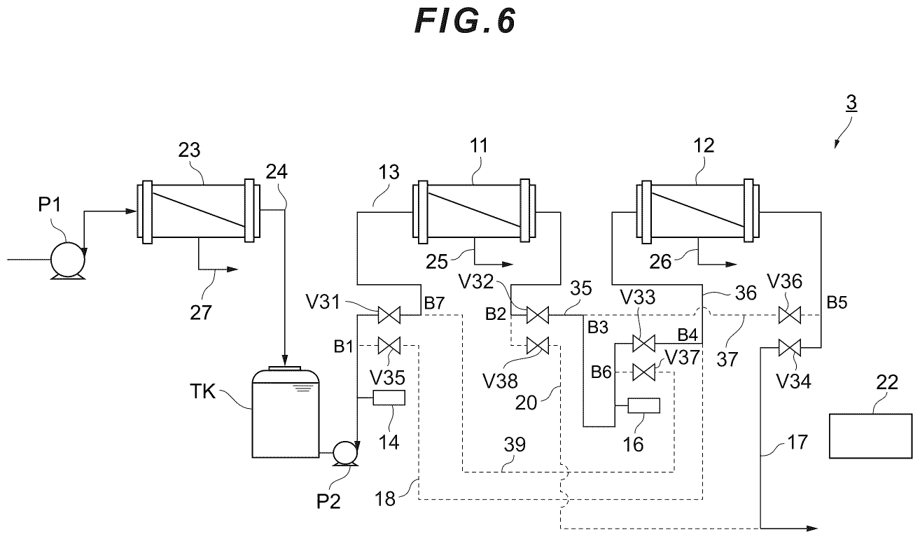

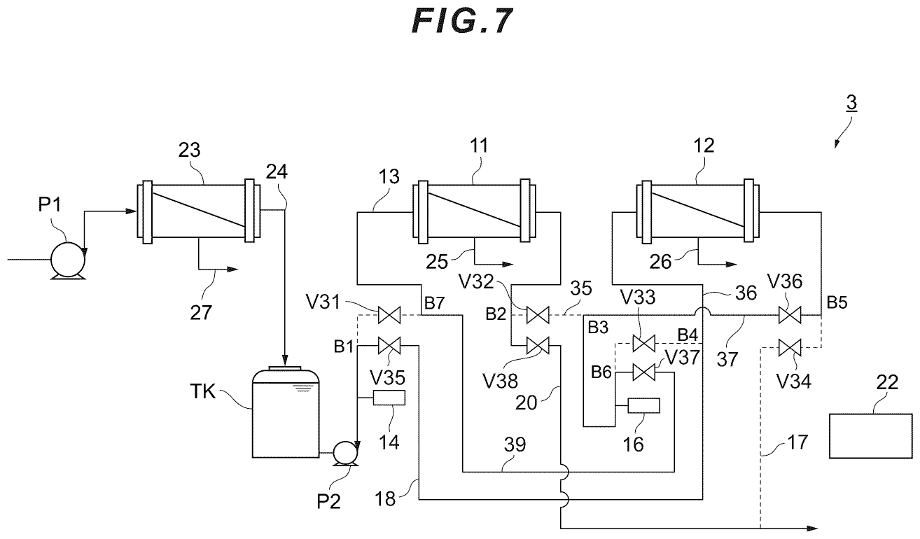

In the pure water production device 3, a first treatment pathway is a flow path which is composed of the feed pipe 13, the reverse osmosis membrane device 11, the feed pipe 35, the feed pipe 36, the reverse osmosis membrane device 12, and the feed pipe 17, and in which the water to be treated is treated by the reverse osmosis membrane device 11 and the reverse osmosis membrane device 12 in this order. In FIG. 6, the first treatment pathway is indicated by solid lines, and the pathways through which the water to be treated are not passed is indicated by broken lines. In addition, a second treatment pathway is a flow path which is composed of the pathway from the upstream side of the branch point B1 of the feed pipe 13 to the branch point B4 through the feed pipe 18, the feed pipe 36, the reverse osmosis membrane device 12, the pathway from the permeation side of the reverse osmosis membrane device 12 to the branch point B5 of the feed pipe 17, the feed pipe 37, the pathway from the branch point B3 of the feed pipe 35 to the branch point B6, the feed pipe 39, the pathway downstream of the branch point B7 of the feed pipe 13, the reverse osmosis membrane device 11, the pathway of the feed pipe 35 from the permeation side of the reverse osmosis membrane device 11 to the branch point B2, and the feed pipe 20, and in which the water to be treated is treated by the reverse osmosis membrane device 12 and the reverse osmosis membrane device 11 in this order. In FIG. 7, the second treatment pathway is indicated by solid lines, and the pathways through which the water to be treated is not passed are indicated by broken lines.

In the pure water production device 3, the water to be treated stored in the tank TK is passed through the first treatment pathway in the first treatment period, and is passed through the second treatment pathway in the second treatment period.

The pure water production device 3 includes a control device 22 that controls opening and closing of the valves V31 to V38 in accordance with a program input in advance. Hereinafter, a switching method between the first treatment period and the second treatment period using the control device 22 will be described.

First, the control device 22 outputs a control signal to open the valves V31, V32, V33, and V34 and close the valves V35, V36, V37, and V38. Consequently, the first treatment pathway is opened, and the pump P2 is operated to start the first treatment period. After the first treatment period is executed for a predetermined period, the control device 22 outputs a control signal to close the valves V31, V32, V33, and V34 and open the valves V35, V36, V37, and V38. Consequently, the second treatment pathway is opened, and the second treatment period starts. After the second treatment period, the control device 22 outputs a control signal to open the valves V31, V32, V33, and V34 and close the valves V35, V36, V37, and V38. Consequently, the first treatment pathway is opened, and the first treatment period resumes. By repeating these steps, the first treatment period and the second treatment period are alternately repeated.

In the pure water production device 3 of the present embodiment, although the hardness component is removed in the reverse osmosis membrane device 23 in the first treatment period, the hardness component leaks into the permeate water of the reverse osmosis membrane device 23 depending on the water quality or the operation period, and scale clogging in the reverse osmosis membrane device 11 may progress. In addition, in the reverse osmosis membrane device 12 that treats acidic water to be treated, scale clogging due to silica is likely to progress. Therefore, before scale clogging of the reverse osmosis membrane devices 11 and 12 deteriorates the water recovery ratio, the order of the reverse osmosis membrane device 11 and the reverse osmosis membrane device 12 is changed, and the second treatment period is executed. In the second treatment period, the reverse osmosis membrane device 11 treats the water to be treated having been adjusted to be acidic, and the hardness scale is dissolved in an acid, and the scale clogging is ameliorated during this process. In addition, in the reverse osmosis membrane device 12 in which scale clogging due to silica has progressed, the silica scale is dissolved in an alkali by treating the water to be treated having been adjusted to be alkaline, and the scale clogging is ameliorated. In the second treatment period, scale clogging in the reverse osmosis membrane devices 11 and 12 may progress in the same manner as described above. However, by interchanging the flow order of the water to be treated through the reverse osmosis membrane device 11 and the reverse osmosis membrane device 12 and executing the first treatment period before the water recovery ratio decreases due to the scale clogging, the scale clogging in the reverse osmosis membrane devices 11 and 12 is ameliorated in the same manner as in the second treatment period. Consequently, progress of scale clogging in the reverse osmosis membrane devices 11 and 12 can be suppressed over a long period, and pure water can thus be stably and efficiently produced over a long period. Furthermore, since the acid and alkali conditions employed in the pure water production device 3 are acid and alkali conditions milder than chemicals generally used for scale cleaning, deterioration of the reverse osmosis membranes can also be suppressed, and pure water with high water quality can be stably produced over a long period as a result.

Incidentally, among the valves V31 to V38, one set of two valves provided at each branch, for example, the valve V31 and the valve V35, the valve V32 and the valve V38, the valve V33 and the valve V37, and the valves V34 and V36 may be combined and replaced with one three-way valve to provide the same flow path switching function. Further, the valves V31, V33, V35, and V37 may be combined as one four-way valve, and the valves V32, V34, V36, and V38 may be combined as another four-way valve to provide the same flow path switching function.

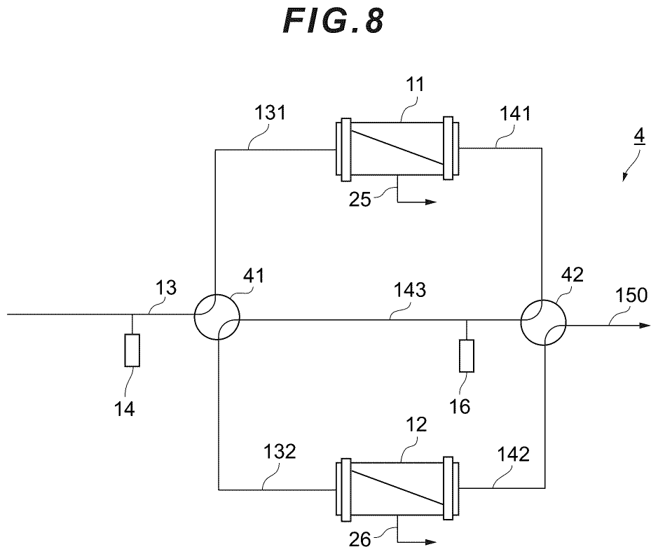

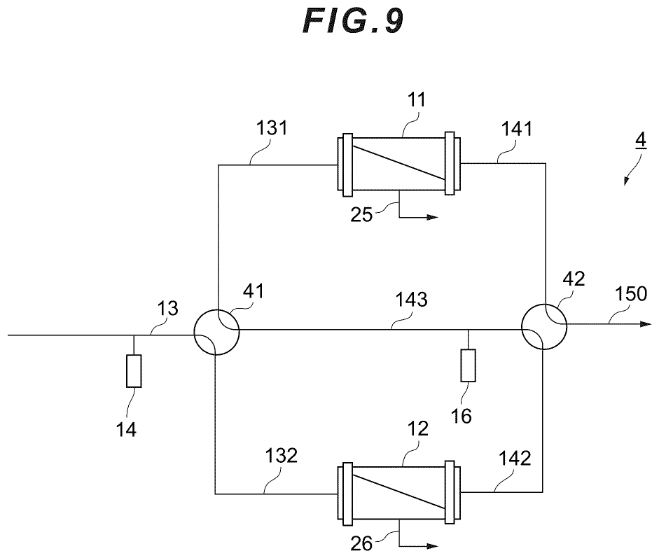

FIGS. 8 and 9 schematically illustrate a pure water production device 4 having a piping configuration in a case where valves V41 and V42, which are two four-way valves, are used. The pure water production device 4 includes the valves V41 and V42, which are four-way valves; a feed pipe 13; a feed pipe 131 connected to the feed side of a reverse osmosis membrane device 11; a feed pipe 141 connected to the permeation side of the reverse osmosis membrane device 11; a feed pipe 132 connected to the feed side of a reverse osmosis membrane device 12; a feed pipe 142 connected to the permeation side of the reverse osmosis membrane device 12; a pipe 143 connecting the valve V41 and the valve V42; and a feed pipe 150 that sends treated water (permeate water) to a subsequent stage. In the pure water production device 4, the feed pipe 131, the feed pipe 132, and the pipe 143 are connected to the feed pipe 13 via the valve V41. The end of the pipe 143 opposite to the connection side to the valve V41 is connected to the valve V42. Further, the feed pipe 141, the feed pipe 142, and the pipe 143 are connected to the feed pipe 150 via the valve V42.

FIG. 8 is a diagram schematically illustrating a treatment pathway in the first treatment period when four-way valves are used. As illustrated in FIG. 8, in the first treatment period, the flow path of the valve V41 is switched such that the feed pipe 13 and the feed pipe 131 are connected and the pipe 143 and the feed pipe 132 are connected. The flow path of the valve V42 is switched such that the feed pipe 141 and the pipe 143 are connected and the feed pipe 142 and the feed pipe 150 are connected. Note that, in FIG. 8, the four-way valve may be changed to a plurality of two-way valves.

FIG. 9 is a diagram schematically illustrating a treatment pathway in the second treatment period when four-way valves are used. As illustrated in FIG. 9, in the second treatment period, the flow path of the valve V41 is switched such that the feed pipe 13 and the feed pipe 132 are connected and the pipe 143 and the feed pipe 131 are connected. The flow path of the valve V42 is switched such that the feed pipe 141 and the feed pipe 150 are connected and the feed pipe 142 and the pipe 143 are connected. Note that, in FIG. 9, the four-way valve may be changed to a plurality of two-way valves.

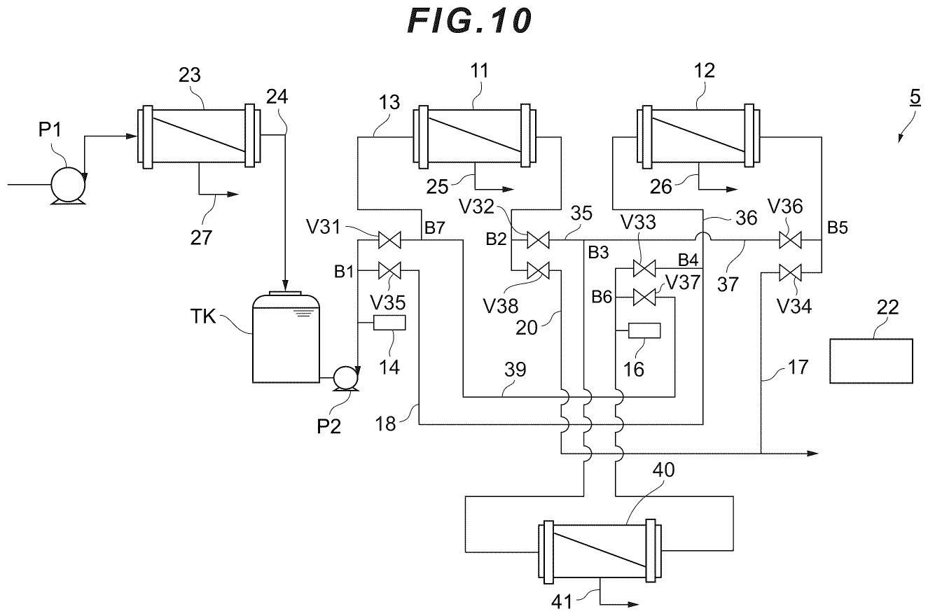

Next, a first modification of the pure water production device 3 illustrated in FIG. 5 will be described with reference to FIG. 10. FIG. 10 is a block diagram diagrammatically illustrating a pure water production device 5 of the first modification. The pure water production device 5 is different from the pure water production device 3 illustrated in FIG. 5 in that a reverse osmosis membrane device 40 is interposed on the downstream side of the branch point B3 of the pathway of the feed pipe 35 and on the upstream side of the acid adjustment mechanism 16, and the reverse osmosis membrane device 40 performs a reverse osmosis membrane treatment of a third stage. The rest is the same as those of the pure water production device 3. Therefore, components providing the same effects are denoted by the same reference numerals, and detailed description thereof is omitted.

In the pure water production device 5, in a first treatment period, the permeate water of the reverse osmosis membrane device 11 is fed to the feed side of the fourth reverse osmosis membrane device 40 via the feed pipe 35. The alkaline water to be treated is treated by the reverse osmosis membrane device 40 to further remove boron and silica, and thereafter, the permeate water of the reverse osmosis membrane device 40 is adjusted to be acidic by the acid adjustment mechanism 16 and is passed through the feed pipe 36 through the branch points B6 and B4. The acidic water to be treated passed through the feed pipe 36 is treated by the reverse osmosis membrane device 12.

In addition, in the pure water production device 5, in the second treatment period, the permeate water of the reverse osmosis membrane device 12 is sent to the branch point B3 via the feed pipe 37, and is fed from the branch point B3 to the feed side of the fourth reverse osmosis membrane device 40 via the feed pipe 35. The alkaline water to be treated is treated by the reverse osmosis membrane device 40 to further remove boron and silica. Thereafter, the permeate water of the reverse osmosis membrane device 40 is adjusted to be acidic by the acid adjustment mechanism 16, and is passed through the branch point B6 to the feed pipe 39. The acidic water to be treated having been passed through the feed pipe 39 is fed to the reverse osmosis membrane device 11 from the feed side from the feed pipe 13 through the branch point B7, and is treated.

By using the pure water production device 5, pure water having a lower boron concentration, for example, a boron concentration of 0.1 ppb (μg/L) or less can be obtained.

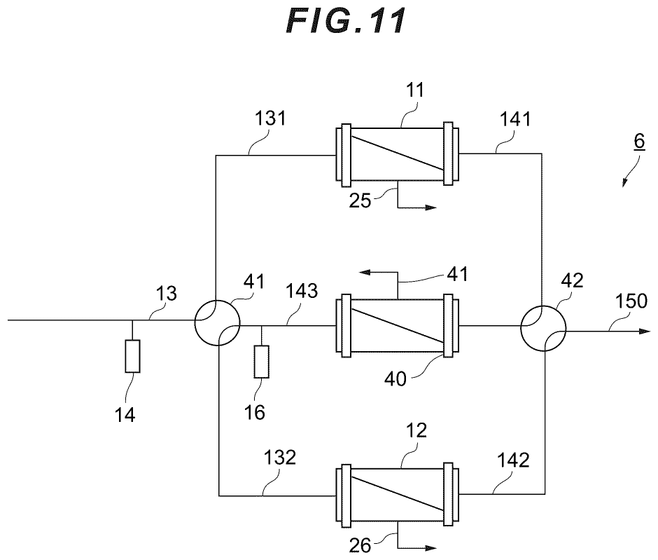

FIG. 11 is a diagram schematically representing a pure water production device 6 in a case where four-way valves are used as the valves of the pure water production device 5 illustrated in FIG. 10. In the pure water production device 6 illustrated in FIG. 11, a reverse osmosis membrane device 40 is interposed into a pathway of a pipe 143 such that the upstream side (the valve V42 side) of the pipe 143 is the feed side and the downstream side (the valve V41 side) of the pipe 143 is the permeation side. In addition, the reverse osmosis membrane device 40 is arranged on the upstream side of an acid adjustment mechanism 16. Consequently, a first treatment pathway through which water to be treated is passed through a reverse osmosis membrane device 11, the reverse osmosis membrane device 40, and a reverse osmosis membrane device 12 in this order and a second treatment pathway through which the water to be treated is passed through the reverse osmosis membrane device 12, the reverse osmosis membrane device 40, and the reverse osmosis membrane device 11 in this order can be configured. In addition, in the pure water production device 6, by switching the flow paths of the valve V41 and the valve V42 in the same manner as in the pure water production device 4, the first treatment period and the second treatment period can be alternately repeated. Note that in FIG. 11, the four-way valve may be changed to a plurality of (for example, two) two-way valves.

Next, a second modification of the pure water production device 3 will be described. This modification has a configuration in which the water passage order is interchanged between the reverse osmosis membrane device 23 and the reverse osmosis membrane device 11, and the first treatment period and the second treatment period are executed in the same manner as in the first modification of the pure water production device 1. In this modification, similar to the first modification of the pure water production device 1, a switching mechanism capable of switching the flow order of the water to be treated through the reverse osmosis membrane device 23 and the reverse osmosis membrane device 11 by using a pipe and a valve is disposed, and a first treatment pathway in which raw water is passed through the reverse osmosis membrane device 23, the alkali adjustment mechanism 14, and the reverse osmosis membrane device 11 in this order, and a second treatment pathway in which the raw water is passed through the reverse osmosis membrane device 11, the alkali adjustment mechanism 14, and the reverse osmosis membrane device 23 in this order are configured. Consequently, the control device 22 controls the switching mechanism to switch the first treatment pathway and the second treatment pathway at each end of a predetermined treatment period, and the first treatment period using the first treatment pathway and the second treatment period using the second treatment pathway can be alternately repeated. At this time, instead of the method in which a pipe for switching flow paths is provided, the swapping can be realized by extracting two reverse osmosis membranes or reverse osmosis membrane modules and interchanging the positions thereof.

In this modification, an acid adjustment mechanism may be provided immediately after the pump P1 in the pathway of the feed pipe 24, and the water to be treated may be adjusted to be acidic and fed to the reverse osmosis membrane device of the first stage. Consequently, the removal ratio of the hardness component in the reverse osmosis membrane device of the first stage can be improved. The acid adjusting agent in this case is the same as that described above, but the pH of the water to be treated is preferably adjusted to 5.0 to 6.0. Also in the pure water production device of the present modification, similar to the first modification of the pure water production device 1, since scale clogging can be ameliorated by swapping the reverse osmosis membrane device 23 and the reverse osmosis membrane device 11, the progress of the scale clogging in the reverse osmosis membrane devices 23 and 11 can be suppressed over a long period, and pure water can be produced stably and efficiently over a long period as a result.

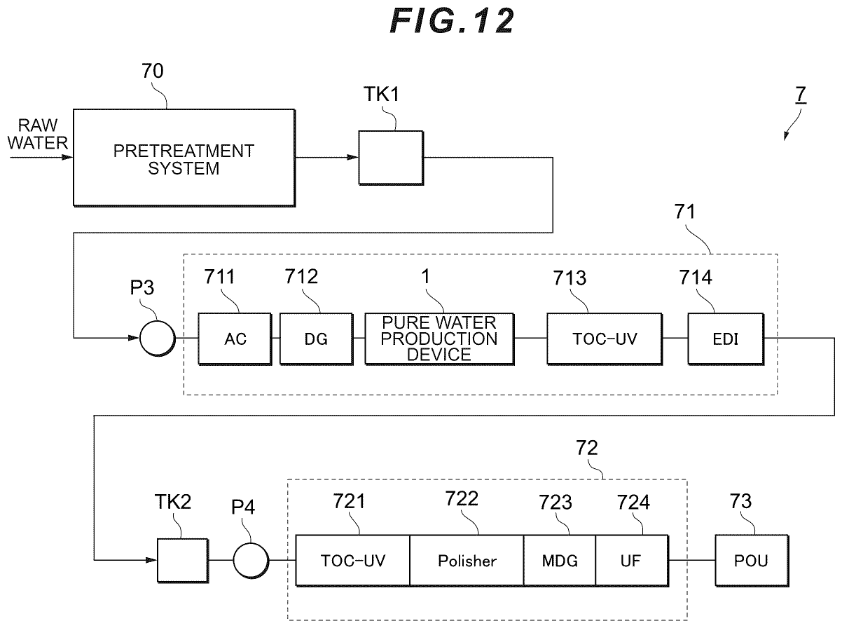

Next, an ultrapure water production system 7 of the present embodiment using the above-described pure water production device 1 will be described with reference to FIG. 12. FIG. 12 is a block diagram diagrammatically illustrating a configuration of the ultrapure water production system 7.

As illustrated in FIG. 12, the ultrapure water production system 7 includes a pretreatment system 70, a primary pure water system 71, and a secondary pure water system (sub-system) 72 in this order. The secondary pure water system 72 is connected to a point of use (POU) 73 by piping, and ultrapure water produced by the ultrapure water production system 7 is fed to the POU 73 thereby.

The pretreatment system 70 performs processes such as coagulation, filtration, and membrane separation, and if necessary, performs temperature control using a heat exchanger or the like to remove turbidity components such as suspended solids and colloidal substances included in water to be treated (raw water). Specifically, for example, the pretreatment system 70 includes an appropriate combination of a coagulation sedimentation device, a pressurized flotation device, a sand filtration device, a microfiltration device, an ultrafiltration device, a heat exchanger, and the like. Note that when the quality of the raw water is sufficient to be fed to the primary pure water system 71, the pretreatment system 70 may be omitted.

The ultrapure water production system 7 includes a tank TK1 in a subsequent stage of the pretreatment system 70, and the water to be treated pretreated by the pretreatment system 70 is introduced into the tank TK1 and temporarily stored. The water to be treated in the tank TK1 is fed to the primary pure water system 71 by a pump P3.

The primary pure water system 71 removes organic substances, ion components, and dissolved gas from the pretreated water to produce primary pure water. The primary pure water system 71 includes the pump P3, an activated carbon unit (AC) 711, a degassing device 712, the pure water production device 1 of the above-described embodiment, an ultraviolet oxidation device (TOC-UV) 713, and an electrodeionizer (EDI) 714 in this order. Note that the pure water production device 1 used in the primary pure water system 71 is preferably configured to include three stages of reverse osmosis membrane devices, the reverse osmosis membrane devices 23, 11, and 12 as water treatment devices. In addition, the primary pure water system 71 may include any of the pure water production devices 2 to 6 of the above-described embodiments or the pure water production devices of the modifications thereof, instead of the pure water production device 1.

In the primary pure water system 71, the activated carbon unit (AC) 711 firstly removes impurities which cause film deterioration, such as hydrogen peroxide and chlorine mixed in the pretreated water.

Thereafter, the degassing device 712 removes carbon dioxide gas in the water to be treated. The degassing device 712 is a vacuum degassing tower that removes dissolved gas in water under vacuum or a membrane degassing device that removes dissolved gas through a degassing membrane. Thereafter, the pure water production device 1 removes an ion component and boron in the treated water of the degassing device 712.

The ultraviolet oxidation device 713 has, for example, an ultraviolet lamp capable of irradiation with ultraviolet light having a wavelength around 185 nm, and the water to be treated is irradiated with ultraviolet light from the ultraviolet lamp to oxidatively decompose total organic carbon (TOC) in the water to be treated. As the ultraviolet lamp used in the ultraviolet oxidation device 713, a lamp that generates ultraviolet light having a wavelength of around 185 nm can be used, and a low-pressure mercury lamp that emits ultraviolet light having a wavelength of around 254 nm together with ultraviolet light having a wavelength of around 185 nm may be used. Water is decomposed by ultraviolet light emitted from the ultraviolet oxidation device 713 to generate OH radicals, and the OH radicals oxidatively decompose organic substances in the water to be treated into organic acids. The ultraviolet irradiation amount in the ultraviolet oxidation device 713 of the primary pure water system can be appropriately changed depending on the water quality of the water to be treated.

The electrodeionizer (EDI) 714 has, for example, an anion exchange membrane and a cation exchange membrane alternately arranged between a positive electrode and a negative electrode, and alternately has a desalination chamber, and a concentration chamber into which concentrated water including a removed ion component flows, with the desalination chamber and the concentration chamber partitioned by the anion exchange membrane and the cation exchange membrane. Then, the electrodeionizer includes a mixture of an anion exchange resin and a cation exchange resin filling the desalination chamber, and an electrode for applying a DC voltage.

In the electrodeionizer 714, for example, the water to be treated is fed in parallel to the desalination chamber and the concentration chamber, and the mixture of the anion exchange resin and the cation exchange resin in the desalination chamber adsorbs the ion component in the water to be treated. The adsorbed ion component is transferred to the concentration chamber by the action of the direct current, and the concentrated water in the concentration chamber is discharged to the outside of the system.

The electrodeionizer 714 can continuously remove the ion component without using any chemicals such as an acid or an alkali to regenerate the ion exchange resins at all. Therefore, it is possible to realize an improvement in safety in production of ultrapure water, a reduction in production costs, a reduction in size of the device, and the like, leading to an improvement in production efficiency.

In addition, in the ultrapure water production system 7 of the present embodiment, since the pure water production device 1 of the above-described embodiment including two or more stages of reverse osmosis membrane devices in which two or more reverse osmosis membrane devices are connected in series is used, the water quality of the water fed to the electrodeionizer 714 is improved. As a result, the load on the electrodeionizer 714 and subsequent devices is reduced, and an improvement in the water quality of ultrapure water obtained is expected.

The primary pure water obtained in this manner has, for example, a resistivity of 17 MΩ·cm or more and a TOC concentration of 10 μgC/L or less.

The ultrapure water production system of the present embodiment includes a primary pure water tank TK2 that stores primary pure water, a pump P4, and the secondary pure water system 72 in this order as subsequent stages of the primary pure water system 71. The primary pure water produced by the primary pure water system is temporarily stored in the primary pure water tank TK2, and then sent to the secondary pure water system 72 by the pump P4. The secondary pure water system 72 includes an ultraviolet oxidation device (TOC-UV) 721, a non-regenerating polisher 722, a membrane degassing device (MDG) 723, and an ultrafiltration device (UF) 724.

The configuration of the ultraviolet oxidation device 721 in the secondary pure water system 72 is the same as that of the ultraviolet oxidation device 721 in the primary pure water system 71. The non-regenerating polisher 722 is a mixed bed type ion exchange resin device configured by filling a container such as a cylinder with a mixture of a strongly acidic cation exchange resin and a strongly basic anion exchange resin. The non-regenerating polisher 722 adsorbs and removes the ion component generated from organic substances decomposed by the ultraviolet oxidation device 721.

The membrane degassing device 723 removes dissolved gas through a degassing membrane. The membrane degassing device 723 removes a small amount of dissolved oxygen in the primary pure water to reduce the dissolved oxygen concentration to, for example, about 1 μg/L or less. The ultrafiltration device 724 performs a filtration treatment using an ultrafiltration membrane to remove a fine particle component and a trace eluted substance from an ion exchange resin on the upstream side, thereby reducing the number of fine particles of, for example, 0.05 μm or more to about 250 Pcs./L or less, for example.

In this manner, the secondary pure water system 72 treats the primary pure water to produce ultrapure water with high purity. The water quality of the ultrapure water is, for example, as follows: the total organic carbon (TOC) concentration is 1 μgC/L or less; the resistivity is 18 MΩ·cm or more; and the boron concentration is 0.1 ppb (μg/L) or less. The ultrapure water produced by the secondary pure water system is fed to the point of use 73.

Incidentally, in each of the above-described embodiments, the water quality of raw water, pretreated water, pure water, or ultrapure water can be measured by the following method or device.
pH: electrode method
Boron concentration: ICP emission spectroscopy/ICP-MS method
Hardness component: ICP-MS method
Dissolved carbon dioxide gas (in terms of calcium carbonate): Sievers M9e manufactured by SUEZ WTS Analytical Instruments, Inc.
Silica (Si): atomic absorption spectroscopy/absorption spectrophotometry
Chlorine (in terms of Cl): DPD method
Electric conductivity: electric conductivity meter (HE-960CW manufactured by HORIBA, Ltd.)
Resistivity (specific resistance): resistivity meter (HE-960RW manufactured by HORIBA, Ltd.)
Total organic carbon (TOC) concentration: TOC analyzer (for non-ultrapure water: Sievers M9e manufactured by SUEZ WTS Analytical Instruments, Inc. ; for ultrapure water: Anatel A-1000XP manufactured by Beckman Coulter, Inc.)
Number of fine particles of 0.05 μm or more: particle counter (UDI-50 manufactured by Particle Measuring Systems, Inc.

### EXAMPLES

Next, Experimental Examples and Example will be described. The present invention is not limited to the following examples.

### Experimental Example 1

Using a pure water production device having three stages of reverse osmosis membrane devices as illustrated in FIG. 5, the relationships between the pH of water to be treated of a reverse osmosis membrane device of the second stage and the boron removal ratio and the resistivity of the treated water were examined. Water to be treated was treated while maintaining the pH of the water to be treated in the reverse osmosis membrane device of the third stage to 4 and changing the pH of the water to be treated in the reverse osmosis membrane device of the second stage, and the boron concentration and resistivity in the permeate water of the reverse osmosis membrane device of the third stage were measured. Using Atsugi city water as raw water, the raw water was subjected to degassing and activated carbon treatment in this order to obtain the water to be treated. This water to be treated was fed to the reverse osmosis membrane device of the first stage without adjustment.

In this experimental example, the quality of the water fed to the reverse osmosis membrane device of the first stage was as follows: the total content ratio of hardness components such as calcium and magnesium and dissolved carbon dioxide gas was 10 mg/L to 300 mg/L in terms of calcium carbonate; the content ratio of silica (Si) was about 1 mg/L to 50 mg/L; chlorine was about 0.1 mg/L to 0.6 mg/L in terms of Cl; and the pH was about 7.2.

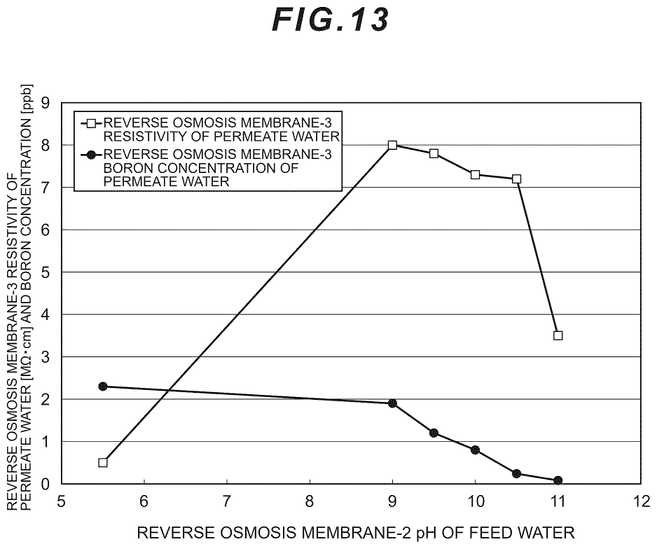

The results of the above are shown in FIG. 13. As shown in FIG. 13, it has been found that the resistivity of the treated water is maximized when the pH of the water to be treated in the reverse osmosis membrane device of the second stage is around 9.0 to 10.5, and the boron removal ratio is improved when the pH is 9.0 or more.

Note that, in FIGS. 13 to 18, the term “reverse osmosis membrane-2” represents the reverse osmosis membrane device of the second stage, and the term “reverse osmosis membrane-3” represents the reverse osmosis membrane device of the third stage.

### Experimental Example 2

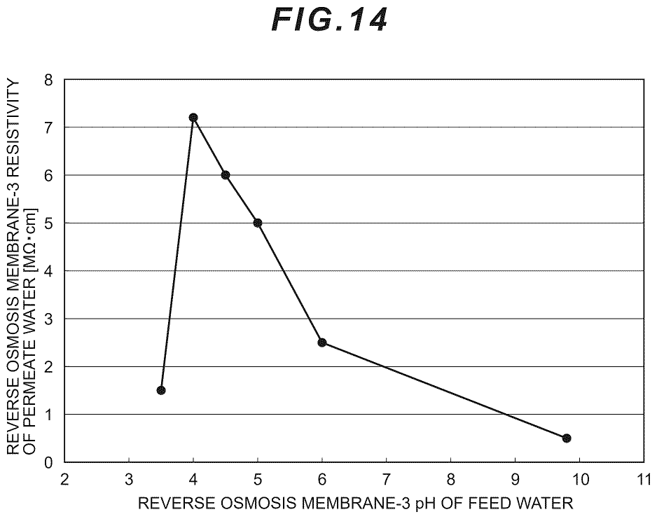

The resistivity of the permeate water of the reverse osmosis membrane device of the third stage was measured while adjusting the pH of the water to be treated in the reverse osmosis membrane device of the second stage to 10.5 and changing the pH of the water to be treated in the reverse osmosis membrane device of the third stage. The relationship between the pH of the water to be treated in the reverse osmosis membrane device of the third stage and the resistivity of the treated water was examined thereby. Results are shown in FIG. 14.

As shown in FIG. 14, it has been found that the resistivity of the treated water is maximized when the pH of the water to be treated in the reverse osmosis membrane device of the third stage is around 4 to 5.5.

### Experimental Example 3

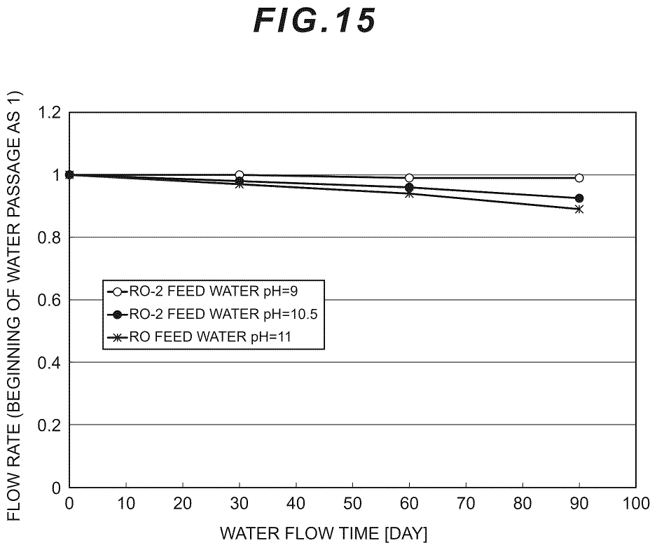

The reverse osmosis membrane device of the second stage illustrated in FIG. 5 was used alone, and the changes in the water flow time and the permeate water flow rate were examined when the pH of the water to be treated was adjusted to 9, 10.5, and 11. Other conditions were same as those in Experimental Example 1. Results are shown in FIG. 15.

As shown in FIG. 15, on the day 90 of the water flow, a flow rate decrease of approximately 1% was observed at pH 9, 7.5% at pH 10.5, and 11% at pH 11.

Note that, in FIG. 15, the abbreviation “RO” represents a reverse osmosis membrane, and the abbreviation “RO-2” represents the reverse osmosis membrane of the second stage.

### Experimental Example 4

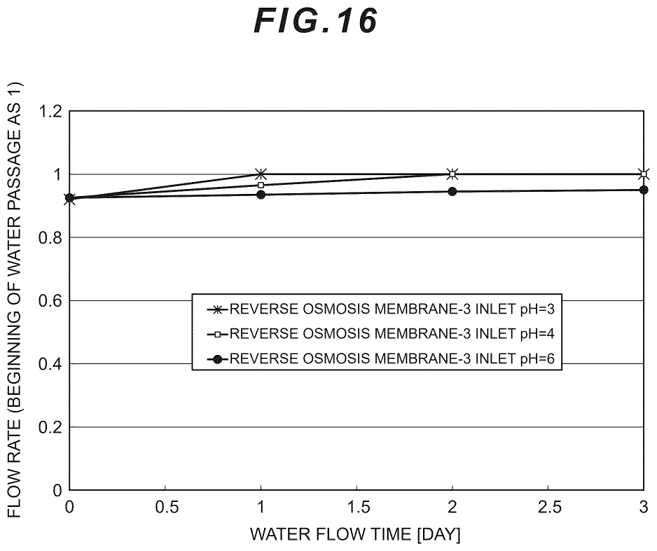

Using, as the reverse osmosis membrane device of the third stage, the reverse osmosis membrane device with the decreased permeate water flow rate after water to be treated with a pH of 10.5 had been passed therethrough for 90 days in Experimental Example 3, the pH of the water to be treated was adjusted to 3, 4, and 6, and the change in the permeate water flow rate immediately after the start of the treatment was examined. Other conditions were same as those in Experimental Example 1. Results are shown in FIG. 16.

As shown in FIG. 16, while the flow rate recovery was about 2% to 3% even after 3 days at around pH 6, the flow rate recovered to the initial value after 2 days at pH 4, and the flow rate recovered to the initial value after 1 day at pH 3.

### Example 1

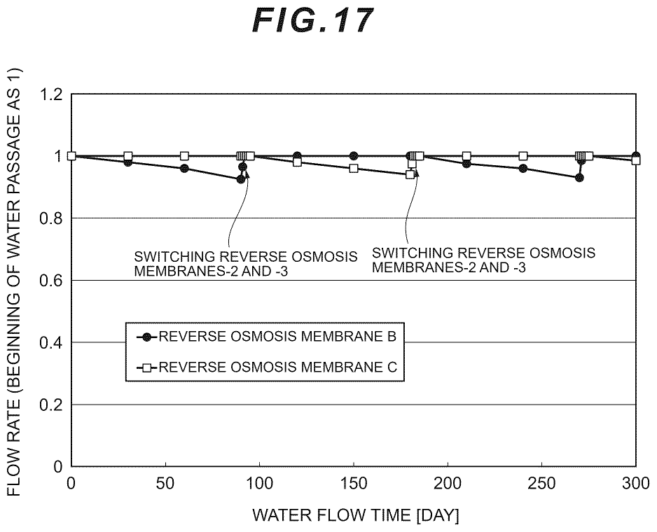

Based on the above results, a pure water production device having three stages of reverse osmosis membrane devices as illustrated in FIG. 5 was used, a reverse osmosis membrane device B was disposed as the reverse osmosis membrane device of the second stage, a reverse osmosis membrane device C was disposed as the reverse osmosis membrane device of the third stage, and water to be treated was treated while switching the order of the reverse osmosis membrane devices B and C by opening and closing valves every 90 days, with the treatment period set to 90 days. Changes in the treated water flow rate (the flow rate of the permeate water of the reverse osmosis membrane device of the third stage) were examined when the pH of the water to be treated of the reverse osmosis membrane device of the second stage was 10.5, and the pH of the water to be treated of the reverse osmosis membrane device of the third stage was 4. The results are shown in FIG. 17.

As shown in FIG. 17, a flow rate decrease of about 7.5% was observed after 90 days of water passage in the reverse osmosis membrane B arranged in the second stage at the beginning of water passage. By switching the flow paths after 90 days of water passage so that the reverse osmosis membrane B was arranged in the third stage and the reverse osmosis membrane C was arranged in the second stage, the flow rate of the reverse osmosis membrane B was recovered to the initial flow rate in about two days after switching. Thereafter, the flow rate of the reverse osmosis membrane C decreased, and the reverse osmosis membranes were switched again after 180 days of water passage.

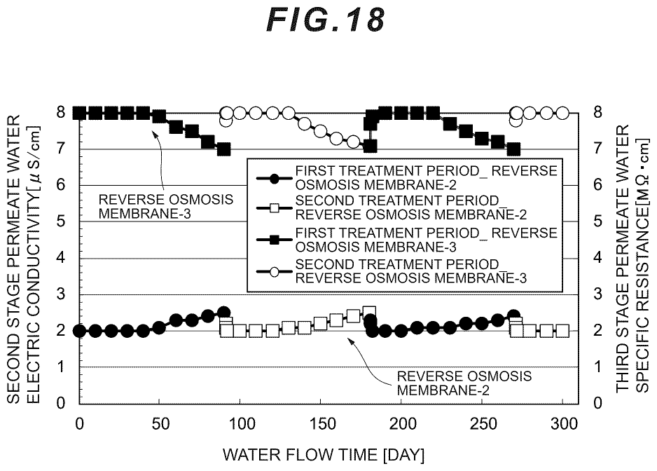

FIG. 18 shows changes in the electric conductivity of the treated water (permeate water) of the reverse osmosis membrane device of the second stage and the specific resistance of the treated water (permeate water) of the reverse osmosis membrane device of the third stage in Example 1. As shown in FIG. 18, immediately before the flow path switching, the permeate water quality of the reverse osmosis membrane devices of the second stage and third stage slightly decreases, but the water quality is recovered by the switching

According to the pure water production device of the Example described above, by switching the water passage order between the reverse osmosis membrane device on the preceding stage side for treating the alkaline water to be treated and the reverse osmosis membrane device on the subsequent stage side for treating the acidic water to be treated at each end of a predetermined treatment period (90 days in this example), scale clogging caused by long-term use can be ameliorated in the water treatment process without conducting a cleaning operation. Therefore, pure water can be stably and efficiently produced over a long period.

1. A pure water production method obtaining pure water from which boron has been removed by passing raw water sequentially through two or more stages of reverse osmosis membranes, wherein
an alkali treatment step of passing alkaline water to be treated through a reverse osmosis membrane of one stage among the reverse osmosis membranes and
an acid treatment step of passing acidic water to be treated through a reverse osmosis membrane of another stage among the reverse osmosis membranes are executed in a predetermined order; and
a first treatment period in which a first reverse osmosis membrane is used in the alkali treatment step and a second reverse osmosis membrane is used in the acid treatment step and
a second treatment period in which the second reverse osmosis membrane is used in the alkali treatment step and the first reverse osmosis membrane is used in the acid treatment step
are repeated at a predetermined interval, with the first reverse osmosis membrane and the second reverse osmosis membrane swapped.

2. The pure water production method according to claim 1, wherein
in the first treatment period, alkaline water to be treated is passed through the first reverse osmosis membrane to execute the alkali treatment step, permeate water of the first reverse osmosis membrane is adjusted to be acidic, and the produced acidic water to be treated is passed through the second reverse osmosis membrane to execute the acid treatment step;
in the second treatment period, alkaline water to be treated is passed through the second reverse osmosis membrane to execute the alkali treatment step, permeate water of the second reverse osmosis membrane is adjusted to be acidic, and the produced acidic water to be treated is passed through the first reverse osmosis membrane to execute the acid treatment step;
the alkaline water to be treated has a pH of 9.0 or higher and 11.0 or lower; and
the acidic water to be treated has a pH of 5.0 or lower.

3. The pure water production method according to claim 2, further comprising:
a step of passing raw water with a pH of 5.0 or higher and 7.5 or lower through a third reverse osmosis membrane, before the alkali treatment step.

4. The pure water production method according to claim 1, wherein
in the first treatment period, acidic water to be treated is passed through the second reverse osmosis membrane to execute the acid treatment step, permeate water of the second reverse osmosis membrane is adjusted to be alkaline, and the produced alkaline water to be treated is passed through the first reverse osmosis membrane to execute the alkali treatment step;
in the second treatment period, acidic water to be treated is passed through the first reverse osmosis membrane to execute the acid treatment step, permeate water of the first reverse osmosis membrane is adjusted to be alkaline, and the produced alkaline water to be treated is passed through the second reverse osmosis membrane to execute the alkali treatment step;
the alkaline water to be treated has a pH of 9.0 or higher and 11.0 or lower; and
the acidic water to be treated has a pH of 5.0 or higher and 6.0 or lower.

5. A pure water production device having two or more reverse osmosis membrane devices connected in series and producing pure water from which boron has been removed, the pure water production device comprising:
a raw water feed pipe that feeds raw water;
a first reverse osmosis membrane device;
a second reverse osmosis membrane device;
a first adjustment mechanism that adjusts water to be treated to be alkaline or acidic;
a second adjustment mechanism that adjusts water to be treated to either acidic or alkaline, reversing the liquid property adjusted by the first adjustment mechanism;
a first treatment pathway allowing raw water to pass through the first adjustment mechanism, the first reverse osmosis membrane device, the second adjustment mechanism, and the second reverse osmosis membrane device in this order;
a second treatment pathway allowing raw water to pass through the first adjustment mechanism, the second reverse osmosis membrane device, the second adjustment mechanism, and the first reverse osmosis membrane device in this order;
a switching mechanism capable of switching the first treatment pathway and the second treatment pathway; and
a control mechanism that controls the switching mechanism to switch the first treatment pathway and the second treatment pathway at each end of a predetermined treatment period.

6. The pure water production device according to claim 5, wherein
the first adjustment mechanism is an alkali adjustment mechanism that adjusts raw water to be alkaline, and
the second adjustment mechanism is an acid adjustment mechanism that adjusts water to be treated to be acidic.

7. The pure water production device according to claim 5, wherein
the first treatment pathway has
a first feed pipe that feeds raw water to a feed side of the first reverse osmosis membrane device,
a second feed pipe that feeds permeate water of the first reverse osmosis membrane device to the second adjustment mechanism,
a third feed pipe that feeds water to be treated after passing through the second adjustment mechanism to a feed side of the second reverse osmosis membrane device,
a fourth feed pipe that sends permeate water of the second reverse osmosis membrane device to a subsequent stage, and
four switching valves interposed into the first to fourth feed pipes, respectively;
the first adjustment mechanism is disposed on an upstream side of the switching valve of the first feed pipe;
the second treatment pathway has
a fifth feed pipe that feeds raw water to the feed side of the second reverse osmosis membrane device,
a sixth feed pipe that feeds permeate water of the second reverse osmosis membrane device to the second adjustment mechanism,
a seventh feed pipe that feeds water to be treated after passing through the second adjustment mechanism to the feed side of the first reverse osmosis membrane device,
an eighth feed pipe that sends permeate water of the first reverse osmosis membrane device to a subsequent stage, and
four switching valves provided interposed into the fifth to eighth feed pipes, respectively;
the first adjustment mechanism is disposed on an upstream side of the switching valve of the sixth feed pipe; and
the control mechanism controls the eight switching valves to switch the first treatment pathway and the second treatment pathway.

8. The pure water production device according to claim 5, wherein
the first adjustment mechanism is an acid adjustment mechanism that adjusts raw water to be weakly acidic; and
the second adjustment mechanism is an alkali adjustment mechanism that adjusts water to be treated to be alkaline.

9. An ultrapure water production system comprising a primary pure water system and a secondary pure water system in this order, wherein
the primary pure water system includes the pure water production device according to claim 5 and, in a subsequent stage thereof, an ultraviolet oxidation device and an electrodeionizer;
the secondary pure water system includes an ultraviolet oxidation device, a non-regenerating polisher, a membrane degassing device, and an ultrafiltration device in this order; and
the ultrapure water production system produces ultrapure water having a boron concentration of 0.1 μg/L or less.
